(19) United States
(12) Patent Application Publication
(10) Pub. No.: US 2025/0067912 A1
(43) Pub. Date: Feb. 27, 2025

(54) LIGHT ABSORBER, LIGHT-ABSORBER-ATTACHED ARTICLE, IMAGING APPARATUS, AND LIGHT-ABSORBING COMPOSITION

(71) Applicant: Nippon Sheet Glass Company, Limited, Tokyo (JP)

(72) Inventor: Yuichiro KUBO, Tokyo (JP)

(21) Appl. No.: 18/713,057

(22) PCT Filed: Nov. 26, 2021
(86) PCT No.: PCT/JP2021/043482

§ 371 Date: May 23, 2024

(51) Int. Cl. G02B 5/20

(52) U.S. Cl. CPC G02B 5/208

(57) ABSTRACT

A transmission spectrum of a light absorber 10 at an incident angle of 0° satisfies the following requirements: (I) an average transmittance in a wavelength range of 450 nm to 600 nm is 75% or more; (II) a first wavelength that lies in a wavelength range of 350 nm to 450 nm and at which a transmittance is 50% is 380 nm or more and 440 nm or less; (III) a second wavelength that lies in a wavelength range of 650 nm to 750 nm and at which a transmittance is 50% is 680 nm or more and 740 nm or less; (IV) a maximum transmittance in a wavelength range of 350 nm to 370 nm is 1% or less; (V) a maximum transmittance in a wavelength range of 800 nm to 900 nm is 5% or less; and (VI) a maximum transmittance in a wavelength range of 1100 nm to 1200 nm is 5% or less.

### TECHNICAL FIELD

The present invention relates to a light absorber, an article with a light absorber, an imaging apparatus, and a light-absorbing composition.

### BACKGROUND ART

In imaging apparatuses employing a solid-state image sensing device such as a charge coupled device (CCD) or a complementary metal oxide semiconductor (CMOS), any of various optical filters is disposed ahead of the solid-state image sensing device in order to obtain an image with good color reproduction. Solid-state image sensing devices generally have spectral sensitivity over a wide wavelength range extending from ultraviolet to infrared regions. On the other hand, the visual sensitivity of humans lies solely in a visible region. Thus, a technique is known in which an optical filter for blocking a portion of infrared or ultraviolet light is disposed ahead of a solid-state image sensing device in an imaging apparatus in order to allow the spectral sensitivity of the solid-state image sensing device to approximate to the visual sensitivity of humans.

It has been common for such an optical filter to block infrared or ultraviolet light by means of light reflection by a dielectric multilayer film. Recent interest has focused on optical filters including a film including a light absorbent. The transmittance properties of an optical filter including a film including a light absorbent are unlikely to be dependent on the incident angle, and this makes it possible to obtain favorable images with less color change even when light is obliquely incident on the optical filter in an imaging apparatus. Good backlit or nightscape images are easily obtainable using light-absorbing type optical filters not including a light-reflecting film because such optical filters can reduce occurrence of ghosting and flare caused by multiple reflection in a light-reflecting film. Moreover, optical filters including a light-absorbent-including film are advantageous also in terms of size reduction and thickness reduction of imaging apparatuses.

Light absorbents formed from a phosphonic acid and a copper ion are known for such use. For example, Patent Literature 1 describes an optical filter including a light-absorbing layer including a light absorbent formed from a copper ion and a phosphonic acid (phenyl-based phosphonic acid) having a phenyl group or a halogenated phenyl group.

Patent Literature 2 describes an optical filter including a UV-IR absorbing layer capable of absorbing infrared light and ultraviolet light. The UV-IR absorbing layer includes a UV-IR absorbent formed from a phosphonic acid and a copper ion. A UV-IR absorbing composition includes, for example, a phenyl-based phosphonic acid and a phosphonic acid (alkyl-based phosphonic acid) having an alkyl group or a halogenated alkyl group so that the optical filter will satisfy predetermined optical properties.

Patent Literature 3 describes an infrared cut filter including an organic-dye-including layer and a copper-phosphonate-including layer.

Patent Literature 4 describes an optical filter including an absorbing layer, a reflective layer, and a transparent substrate. A spectral transmittance curve of the optical filter at an incident angle of 0° satisfies given requirements. The absorbing layer includes a near-infrared-absorbing dye such as a squarylium dye.

### CITATION LIST

### Patent Literature

Patent Literature 1: JP 6339755 B1
Patent Literature 2: JP 6232161 B1
Patent Literature 3: JP 6281023 B1
Patent Literature 4: WO 2020/004641 A1

### SUMMARY OF INVENTION

### Technical Problem

Regarding the optical filters described in Patent Literatures 1 to 3, the cut-off wavelength near an infrared region is adjusted within the range of 600 to 680 nm. This is advantageous in terms of satisfactorily blocking infrared light, but is disadvantageous in terms of increasing the transmittance in a red band. Meanwhile, the optical filter described in Patent Literature 4 needs a reflective layer to supplement the insufficient light blocking performance of the absorbing layer with the reflective layer although a wavelength that lies near the infrared region and at which the transmittance is 50% is 680 nm or more. A complicated step of forming the reflective layer is therefore required for the optical filter described in Patent Literature 4.

Therefore, the present invention provides a light absorber likely to have a high transmittance in a visible light region, particularly in a red band, the light absorber being capable of blocking near-infrared light satisfactorily.

### Solution to Problem

The present invention provides a light absorber having a transmission spectrum at an incident angle of 0°, the transmission spectrum satisfying the following requirements (I), (II), (III), (IV), (V), and (VI):
(I) an average transmittance in a wavelength range of 450 nm to 600 nm is 75% or more;
(II) a first wavelength that lies in a wavelength range of 350 nm to 450 nm and at which a transmittance is 50% is 380 nm or more and 440 nm or less;
(III) a second wavelength that lies in a wavelength range of 650 nm to 750 nm and at which a transmittance is 50% is 680 nm or more and 740 nm or less;
(IV) a maximum transmittance in a wavelength range of 350 nm to 370 nm is 1% or less;
(V) a maximum transmittance in a wavelength range of 800 nm to 900 nm is 5% or less; and
(VI) a maximum transmittance in a wavelength range of 1100 nm to 1200 nm is 5% or less.

The present invention also provides an article with a light absorber including:
an article; and
the light absorber provided on a portion of a surface of the article.

The present invention also provides a light-absorbing composition capable of being cured into a light absorber that shows a transmission spectrum at an incident angle of 0°, the transmission spectrum satisfying the following requirements (i), (ii), (iii), (iv), (v), and (vi):
(i) an average transmittance in a wavelength range of 450 nm to 600 nm is 75% or more;
(ii) a first wavelength that lies in a wavelength range of 350 nm to 450 nm and at which a transmittance is 50% is 380 nm or more and 440 nm or less;
(iii) a second wavelength that lies in a wavelength range of 650 nm to 750 nm and at which a transmittance is 50% is 680 nm or more and 740 nm or less;
(iv) a maximum transmittance in a wavelength range of 350 nm to 370 nm is 1% or less;
(v) a maximum transmittance in a wavelength range of 800 nm to 900 nm is 5% or less; and
(vi) a maximum transmittance in a wavelength range of 1100 nm to 1200 nm is 5% or less.

### Advantageous Effects of Invention

The light absorber is likely to have a high transmittance in a visible light region, particularly in a red band. Moreover, the light absorber can block near-infrared light satisfactorily.

### BRIEF DESCRIPTION OF DRAWINGS

FIG. 1A is a cross-sectional view showing an example of a light absorber according to the present invention.

FIG. 1B is a cross-sectional view showing an example of an article with a light absorber according to the present invention.

FIG. 1C is a cross-sectional view showing another example of an article with a light absorber according to the present invention.

FIG. 1D is a cross-sectional view showing an example of an optical member including the light absorber according to the present invention.

FIG. 2 shows an example of an imaging apparatus according to the present invention.

FIG. 3A shows transmission spectra of an optical filter according to Example 1.

FIG. 3B shows transmission spectra of the optical filter according to Example 1.

FIG. 3C shows transmission spectra of the optical filter according to Example 1.

FIG. 4A shows transmission spectra of an optical filter according to Example 2.

FIG. 4B shows transmission spectra of the optical filter according to Example 2.

FIG. 4C shows transmission spectra of the optical filter according to Example 2.

FIG. 5A shows transmission spectra of an optical filter according to Example 3.

FIG. 5B shows transmission spectra of the optical filter according to Example 3.

FIG. 5C shows transmission spectra of the optical filter according to Example 3.

FIG. 6 shows a transmission spectrum of an optical filter according to Comparative Example 1.

FIG. 7 shows a transmission spectrum of an optical filter according to Comparative Example 2.

FIG. 8 shows a transmission spectrum of an optical filter according to Comparative Example 3.

FIG. 9 shows a transmission spectrum of an optical filter according to Comparative Example 4.

FIG. 10 shows a transmission spectrum of an optical filter according to Example 9.

### DESCRIPTION OF EMBODIMENTS

It is conceivable, for example, to equip a vehicle with, as part of an in-vehicle system, a camera including a CMOS sensor or the like. It is also conceivable to include such a camera in a driving apparatus, a moving apparatus, or a conveyance apparatus such as a drone, an autonomous robot, or the like. In such cases, the camera is used mainly to obtain information, such as images, of external conditions, and drivers, operators, and behaviors of automatic steering control systems can be supported on the basis of the obtained information. In this situation, a camera including an optical filter that has a high transmittance in a visible region and that is capable of satisfactorily blocking infrared light has an advantage in that the external environment is recognized with higher accuracy. The term “visible region” refers to a range of wavelengths of electromagnetic waves that humans can recognize as light. The lower limit of the wavelength range is 360 to 400 nm, and the upper limit of the wavelength range is 760 to 830 nm. According to Japanese Industrial Standards (JIS) Z 8120:2001, a visible region can be in the range of 380 to 780 nm. Infrared light, particularly near-infrared light (NIR), is defined as an electromagnetic wave having a wavelength beyond a visible region and up to around 1400 nm.

Red color sometimes represents danger or safety on traffic lights, road signs, and the like. Examples thereof include red lights and, in the category of traffic signs (road signs), regulatory signs indicating no vehicle entry, stop, slow, etc. For accurate recognition of nearby objects including, for example, red lights and regulatory signs as described above, it is important that the transmittance in a wavelength range corresponding to red color is high in a transmission spectrum of an optical filter. Red colors on regulatory signs, etc. have a high reflectance, for example, in a wavelength range from a minimum of 580 to 620 nm to a maximum of more than 780 nm, although the wavelength range depends on specifications of members such as retro-reflective sheets. Assuming that the maximum wavelength of a visible region is 780 nm, an optical filter is advantageous when the transmittance in the wavelength range of 580 nm to 780 nm, 620 nm to 760 nm, or 620 nm to 750 nm is high in a transmission spectrum of the optical filter.

Furthermore, an optical filter's being capable of satisfactorily blocking infrared light is important so as to ease a problem such as a camera's being affected by infrared sensing by a vehicle running nearby, a moving apparatus, or a conveyance apparatus and thus incapable of taking good images. It is understood that the properties of the optical filter described in Patent Literature 4 are adjusted from this perspective. However, the optical filter described in Patent Literature 4 includes a reflective layer in addition to an absorbing layer. Therefore, the present inventor went through a lot of trial and error to develop a technique capable of increasing the transmittance in a red band and satisfactorily blocking near-infrared light without a reflective layer. The present inventor has consequently completed the present invention.

Unless otherwise specified, the terms “visible region” and “visible light region” are each herein defined as the range from 380 nm to 780 nm, and the term “red band” is defined as a band ranging from 580 nm to 780 nm or a portion of the range. Unless otherwise specified, infrared light is herein defined as light (electromagnetic wave) having a wavelength belonging to a range from a wavelength higher than 780 nm, which is the upper limit of the visible region, to 1400 nm, and corresponds to near-infrared light (NIR). Ultraviolet light is herein defined as light (electromagnetic wave) having a wavelength belonging to a range from 280 nm to 380 nm, which is the lower limit of the visible region, and corresponds to a portion of UV-A and UV-B.

Embodiments of the present invention will be described hereinafter. The following description relates to examples of the present invention, and the present invention is not limited to the embodiments given below.

### (Light Absorber)

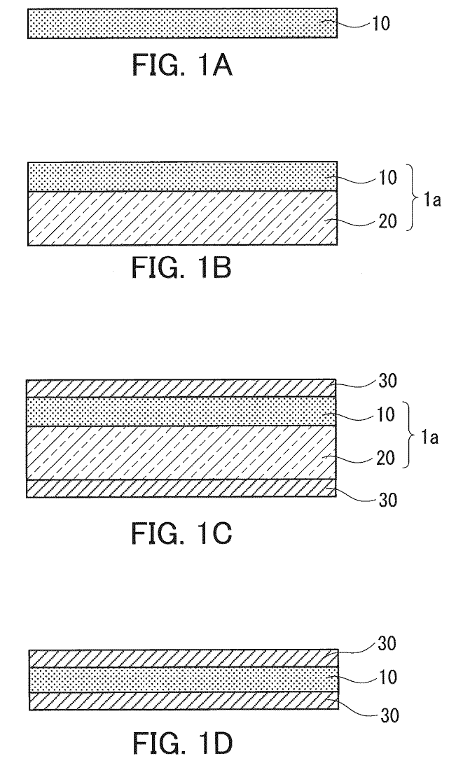

FIG. 1A is a cross-sectional view showing a light absorber 10. A transmission spectrum of the light absorber 10 at an incident angle of 0° satisfies the following requirements (I), (II), (III), (IV), (V), and (VI):
(I) an average transmittance T^{A}₀₍₄₅₀₋₆₀₀₎ in a wavelength range of 450 nm to 600 nm is 75% or more;
(II) a first wavelength λ⁵⁰_{0(UV)} that lies in a wavelength range of 350 nm to 450 nm and at which a transmittance is 50% is 380 nm or more and 440 nm or less;
(III) a second wavelength λ⁵⁰_{0(IR)} that lies in a wavelength range of 650 nm to 750 nm and at which a transmittance is 50% is 680 nm or more and 740 nm or less;
(IV) a maximum transmittance T^{M}₀₍₃₅₀₋₃₇₀₎ in a wavelength range of 350 nm to 370 nm is 1% or less;
(V) a maximum transmittance T^{M}₀₍₈₀₀₋₉₀₀₎ in a wavelength range of 800 nm to 900 nm is 5% or less; and
(VI) a maximum transmittance T^{M}₀₍₁₁₀₀₋₁₂₀₀₎ in a wavelength range of 1100 nm to 1200 nm is 5% or less.

Since the requirements (I), (II), and (III) are satisfied, the transmittance in the visible light region is likely to be high; in particular, since the requirement (III) is satisfied, the transmittance of the light absorber 10 in the red band is likely to be high. Additionally, since the requirements (V) and (VI) are satisfied, the light absorber 10 can satisfactorily block infrared light. Moreover, since the requirement (IV) is satisfied, the light absorber 10 can satisfactorily block ultraviolet light.

As for the requirement (I), the average transmittance T^{A}₀₍₄₅₀₋₆₀₀₎ is desirably 80% or more, and more desirably 85% or more. Furthermore, the transmission spectrum of the light absorber 10 at an incident angle of 0° desirably further satisfies the following requirement (Ia).
(Ia) an average transmittance T^{A}₀₍₆₅₀₋₆₇₀₎ in a wavelength range of 650 nm to 670 nm is 70% or more.

As for the requirement (Ia), the average transmittance T^{A}₀₍₆₅₀₋₆₇₀₎ is desirably 72% or more, and more desirably 74% or more.

As for the requirement (II), the first wavelength λ⁵⁰_{0(UV)} is desirably 385 nm or more and 420 nm or less, and more desirably 390 nm or more and 410 nm or less.

As for the requirement (III), the second wavelength λ⁵⁰_{0(IR)} is desirably more than 680 nm and 740 nm or less, more desirably 685 nm or more and 730 nm or less, and even more desirably 690 nm or more and 720 nm or less.

As for the requirement (IV), the maximum transmittance T^{M}₀₍₃₅₀₋₃₇₀₎ is desirably 0.5% or less.

As for the requirement (V), the maximum transmittance T^{M}₀₍₈₀₀₋₉₀₀₎ is desirably 3% or less.

As for the requirement (VI), the maximum transmittance T^{M}₀₍₁₁₀₀₋₁₂₀₀₎ is desirably 3% or less.

The transmission spectrum of the light absorber 10 at an incident angle of 0° further satisfies, for example, the following requirement (VII). In this case, the light absorber 10 is likely to have a high transmittance in the red band more reliably.
(VII) a transmittance T₀₍₇₅₀₎ at a wavelength of 750 nm is 7% or more.

As for the requirement (VII), the transmittance T₀₍₇₅₀₎ is desirably 10% or more, and more desirably 15% or more.

The transmission spectrum of the light absorber 10 at an incident angle of 0° further satisfies, for example, the following requirement (VIII). In this case, the light absorber 10 is likely to have a high transmittance in the red band more reliably.
(VIII) a transmittance T₀₍₇₈₀₎ at a wavelength of 780 nm is 3% or more.

As for the requirement (VIII), the transmittance T₀₍₇₈₀₎ is desirably 4% or more, and more desirably 5% or more.

A transmission spectrum of the light absorber 10 at an incident angle of 55° has, for example, a third wavelength λ⁵⁰_{55(UV)} that lies in a wavelength range of 350 nm to 450 nm and at which a transmittance is 50%. An absolute value Δλ⁵⁰_{0/55(UV)} of a difference between the third wavelength λ⁵⁰_{55(UV)} and the first wavelength λ⁵⁰_{0(UV)} is, for example, 12 nm or less. This is likely to reduce the incident angle dependency of the transmission spectrum of the light absorber 10. Hence, for example, color change in a central portion and a peripheral portion of an image obtained using an imaging apparatus including the light absorber 10 can be reduced. Additionally, color change on an image of a subject can be reduced, the image being obtained using an imaging apparatus including the light absorber 10, the subject being present in the angle of view of the imaging apparatus. The absolute value Δλ⁵⁰_{0/55(UV)} is desirably 10 nm or less, more desirably 8 nm or less, and even more desirably 6 nm or less.

The transmission spectrum of the light absorber 10 at an incident angle of 55° has, for example, a fourth wavelength λ⁵⁰_{55(IR)} that lies in a wavelength range of 650 nm to 750 nm and at which a transmittance is 50%. An absolute value Δλ⁵⁰_{0/55(IR)} of a difference between the fourth wavelength λ⁵⁰_{55(IR)} and the second wavelength λ⁵⁰_{0(IR)} is, for example, 24 nm or less. This is likely to reduce the incident angle dependency of the transmission spectrum of the light absorber 10. Hence, for example, color change can be reduced in a central portion and a peripheral portion of an image obtained by an imaging apparatus including the light absorber 10. Additionally, color change on an image of a subject can be reduced, the image being obtained using an imaging apparatus including the light absorber 10, the subject being present in the angle of view of the imaging apparatus. The absolute value Δλ⁵⁰_{0/55(IR)} is desirably 20 nm or less, more desirably 18 nm or less, and even more desirably 16 nm or less.

A transmission spectrum of the light absorber 10 at an incident angle of 45° has, for example, a wavelength λ⁵⁰_{45(UV)} that lies in the wavelength range of 350 nm to 450 nm and at which the transmittance is 50%. An absolute value Δ>⁵⁰_{0/45(UV)} of a difference between the wavelength λ⁵⁰_{45(UV)} and the first wavelength λ⁵⁰_{0(UV)} is, for example, 10 nm or less, desirably 8 nm or less, and more desirably 5 nm or less.

A transmission spectrum of the light absorber 10 at an incident angle of 35° has, for example, a wavelength λ⁵⁰_{35(UV)} that lies in the wavelength range of 350 nm to 450 nm and at which the transmittance is 50%. An absolute value Δλ⁵⁰_{0/35(UV)} of a difference between the wavelength λ⁵⁰_{35(UV)} and the first wavelength λ⁵⁰_{0(UV)} is, for example, 8 nm or less, desirably 6 nm or less, and more desirably 4 nm or less.

The transmission spectrum of the light absorber 10 at an incident angle of 45° has, for example, a wavelength λ⁵⁰_{45(IR)} that lies in the wavelength range of 650 nm to 750 nm and at which the transmittance is 50%. An absolute value Δλ⁵⁰_{0/45(IR)} of a difference between the wavelength λ⁵⁰_{45(IR)} and the second wavelength λ⁵⁰_{0(IR)} is, for example, 18 nm or less, desirably 16 nm or less, and more desirably 12 nm or less.

The transmission spectrum of the light absorber 10 at an incident angle of 35° has, for example, a wavelength λ⁵⁰_{35(IR)} that lies in the wavelength range of 650 nm to 750 nm and at which the transmittance is 50%. The absolute value Δλ⁵⁰_{0/35(IR)} of a difference between the wavelength λ⁵⁰_{35(IR)} and the second wavelength λ⁵⁰_{0(IR)} is, for example, 12 nm or less, desirably 10 nm or less, and more desirably 8 nm or less.

The light absorber 10 typically includes a given light absorbent. The light absorbent included in the light absorber 10 is not limited to a particular substance as long as the transmission spectrum of the light absorber 10 at an incident angle of 0° satisfies the requirements (I) to (VI). The light absorber 10, for example, includes, as the light absorbent, a light-absorbing compound including a phosphonic acid and a copper component, and may include an ultraviolet absorbent that absorbs at least a portion of ultraviolet light. The light absorber 10 is in a solid form and is, for example, an independent film or a film on a given object. The light absorber 10 can be produced by curing a liquid light-absorbing composition being a precursor of the light absorber 10. When the light absorber 10 includes a compound capable of exhibiting a given function, the light-absorbing composition being a precursor of the light absorber 10 can naturally include the compound or a precursor thereof.

### (Phosphonic Acid)

The phosphonic acid in the light-absorbing compound included in the light absorber 10 or the light-absorbing composition is not limited to a particular phosphonic acid as long as the transmission spectrum of the light absorber 10 at an incident angle of 0° satisfies the requirements (I) to (VI). The phosphonic acid is, for example, represented by the following formula (a). In the formula (a), R₁ is an alkyl group or a halogenated alkyl group in which at least one hydrogen atom in an alkyl group is substituted by a halogen atom. In this case, a transmission band of the light absorber 10 is likely to extend to a wavelength around 700 nm, and the light absorber 10 is likely to have desired transmittance properties.

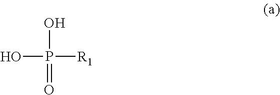

The phosphonic acid is, for example, methylphosphonic acid, ethylphosphonic acid, normal (n-)propylphosphonic acid, isopropylphosphonic acid, normal (n-)butylphosphonic acid, isobutylphosphonic acid, sec-butylphosphonic acid, tert-butylphosphonic acid, or bromomethylphosphonic acid.

### (Copper Component)

The copper component in the light-absorbing compound included in the light absorber 10 or the light-absorbing composition is a concept including a copper ion, a copper complex, a copper-including compound, and the like. The copper component can have preferable absorption properties with respect to a portion of light belonging to near-infrared region and high light transmitting properties with respect to light in a visible region extending from 450 nm to 680 nm. Specifically, by electronic transition in the d-orbital of a divalent copper ion, the copper component selectively absorbs light having a wavelength corresponding to this energy to exhibit excellent near-infrared absorption properties, the wavelength belonging to a near-infrared region. In particular, a divalent copper ion may be mixed, in a copper salt state, with the phosphonic acid to form a copper complex (copper salt) with the phosphonic acid coordinating to the copper ion.

A source of the copper component to which the phosphonic acid coordinates may be, but not limited to, an anhydride or a hydrate of a copper organic acid salt, such as copper acetate, copper benzoate, copper pyrophosphate, or copper stearate, or a mixture thereof. One of these copper salts may be used alone, or two or more of these copper salts or a mixture thereof may be used.

The amounts of the copper component and the phosphonic acid in the light absorber 10 are not limited to particular values. A ratio of the amount of the phosphonic acid to the amount of the copper component in the light absorber 10 is, for example, 0.3 to 1.5 on an amount-of-substance (mole) basis. The ratio of the amount of the phosphonic acid to the amount of the copper component in the light absorber 10 may be preferably 0.4 to 1.4, more preferably 0.6 to 1.2, or even more preferably 0.8 to 1.1.

### (Phosphoric Acid Ester)

The light absorber 10 or the light-absorbing composition may further include, for example, a phosphoric acid ester compound. The phosphoric acid ester facilitates appropriate dispersion of the light-absorbing compound in the light absorber 10. The phosphoric acid ester may function as a dispersant for the light-absorbing compound. A portion of the phosphoric acid ester may react with a metal component to form a compound. For example, the phosphoric acid ester may coordinate to the light-absorbing compound, may react with the light-absorbing compound, or may partly form a complex with the copper component. As long as the light absorber 10 satisfies the requirements relating to the given transmission spectra, the compound including the phosphoric acid ester and the copper component also may absorb light having a wavelength in a given range. The light absorber 10 or the light-absorbing composition may be substantially free of the phosphoric acid ester as long as the light-absorbing substance including at least the phosphonic acid and the copper component can be suitably dispersed in the light-absorbing composition being a precursor of the light absorber 10. Furthermore, for example, when the light-absorbing composition includes an alkoxysilane monomer as described later to impart a dispersing function, the amount of the phosphoric acid ester added can be decreased.

The phosphoric acid ester is not limited to a particular phosphoric acid ester or a compound of a particular phosphoric acid ester. The phosphoric acid ester has, for example, a polyoxyalkyl group. Examples of such a phosphoric acid ester include PLYSURF A208N (polyoxyethylene alkyl (C12, C13) ether phosphoric acid ester), PLYSURF A208F (polyoxyethylene alkyl (C8) ether phosphoric acid ester), PLYSURF A208B (polyoxyethylene lauryl ether phosphoric acid ester), PLYSURF A219B (polyoxyethylene lauryl ether phosphoric acid ester), PLYSURF AL (polyoxyethylene styrenated phenylether phosphoric acid ester), PLYSURF A212C (polyoxyethylene tridecyl ether phosphoric acid ester), and PLYSURF A215C (polyoxyethylene tridecyl ether phosphoric acid ester). All of these are products manufactured by DKS Co., Ltd. Examples of the phosphoric acid ester include NIKKOL DDP-2 (polyoxyethylene alkyl ether phosphoric acid ester), NIKKOL DDP-4 (polyoxyethylene alkyl ether phosphoric acid ester), and NIKKOL DDP-6 (polyoxyethylene alkyl ether phosphoric acid ester). All of these are products manufactured by Nikko Chemicals Co., Ltd. One of these phosphoric acid ester compounds may be used alone, or two or more of these may be used in combination.

The amounts of the phosphonic acid and the phosphoric acid ester in the light absorber 10 are not limited to particular values. A ratio of the amount of the phosphonic acid to the amount of the phosphoric acid ester in the light absorber 10 is, for example, 0.6 to 1.6 on a mass basis. In this case, hydrolysis of the phosphoric acid ester is reduced and the light absorber 10 is likely to have high weather resistance, the hydrolysis being caused by bringing the light absorber 10 into contact with water vapor. The ratio of the amount of the phosphonic acid to the amount of the phosphoric acid ester in the light absorber 10 may be preferably 0.7 to 1.5, and more preferably 0.8 to 1.4.

A ratio of the amount of the copper component to the amount of a phosphorus component in the light absorber 10 is not limited to a particular value. The ratio of the amount of the copper component to the amount of the phosphorus component in the light absorber 10 is, on a mass basis, for example, 1.0 to 3.0, and may be preferably 1.5 to 2.0. The phosphorus component may be derived from the phosphonic acid included in the light absorber 10 or the light-absorbing composition being a precursor thereof, may be derived from the phosphonic acid and the phosphoric acid ester included in the light absorber 10 or the light-absorbing composition being a precursor thereof, or may be included in an additive.

### (Alkoxysilane or its Hydrolysate)

The light absorber 10 or the light-absorbing composition may further include, for example, an alkoxysilane. The term “alkoxysilane” includes monomers of alkoxysilanes and hydrolysates of some of the monomers. The presence of the alkoxysilane can prevent particles of the light absorbent from aggregating with each other. This allows the light absorbent to be dispersed well in the light-absorbing composition or the light absorber being a cured product of the light-absorbing composition even when the amount of the above phosphoric acid ester is decreased. Desirably, in the case where the light absorber or a light-absorbing filter is produced using the light-absorbing composition, a siloxane bond (—Si—O—Si—) is formed by a treatment for sufficient hydrolysis and polycondensation reactions of the alkoxysilane and thus the light absorber has high moisture resistance. The light absorber additionally has high thermal resistance. This is because a siloxane bond is greater in binding energy and chemically more stable than bonds such as a —C—C— bond and a —C—O— bond and is thus excellent in heat resistance and moisture resistance.

In the case where the light-absorbing composition includes the alkoxysilane, exposure to an atmosphere having a relatively high humidity for a certain period of time, which is what is called a humidification treatment, may be performed to cure the light-absorbing composition for production of the light absorber. It is thought that by the humidification treatment, a water component in the atmosphere promotes hydrolysis of the alkoxysilane included in the light-absorbing composition or the light absorber, facilitating formation of a siloxane bond. Moreover, by the humidification treatment, the light absorber 10 in which the fine particles including the light absorbent are not aggregated and that is hard and dense can be formed.

The alkoxysilane is not limited to a particular alkoxysilane as long as the light absorber 10 includes a hydrolysis-polycondensation compound formed by hydrolysis and polycondensation reactions and having a siloxane bond. The alkoxysilane may be, for example, such a monomer as tetramethoxysilane, tetraethoxysilane, methyltrimethoxysilane, methyltriethoxysilane, dimethyl diethoxysilane, dimethyldimethoxysilane, phenyltrimethoxysilane, phenyltriethoxysilane, 3-glycidoxypropyltrimethoxysilane, 3-glycidoxypropyltriethoxysilane, or 3-glycidoxypropylmethyldiethoxysilane, or may be a dimer, an oligomer, or the like formed by bonding a monomer selected from some of the above monomers.

### (Curable Resin)

The light absorber 10 or the light-absorbing composition further includes, for example, a curable resin. The resin is required to be capable of holding the above light-absorbing compound including the phosphonic acid and the copper component in a dispersed or dissolved state. Moreover, it is desirable that the resin be liquid in an uncured or unreacted state and that the resin be capable of allowing the above light-absorbing compound including the phosphonic acid and the copper component to be dispersed or dissolved therein. Furthermore, it is desirable that when the resin is in an uncured, liquid state and the light-absorbing compound is dispersed or dissolved therein, the resin can form a coating film by applying the resin to any object by a coating technique such as spin coating, spraying, dipping, or dispensing. The object on which the coating film is formed is a substrate having any surface, whether plane or curved. It is desirable that the uncured, liquid resin be curable by heating, humidification, irradiation with energy such as light, or a combination of these. The resin is not limited to a particular resin as long as the transmission spectrum of the light absorber 10 at an incident angle of 0° satisfies the requirements (I) to (VI) or a transmission spectrum of a plate-shaped 1 mm-thick body having a flat and smooth surface and formed by curing the resin satisfies the following requirement: the transmittance in the wavelength range of 450 nm to 800 nm is 90% or more. Examples of the resin include cyclic polyolefin resins, epoxy resins, polyimide resins, modified acrylic resins, silicone resins, and polyvinyl resins such as PVB.

### (Curing Catalyst)

The light absorber 10 or the light-absorbing composition being a precursor thereof may include a curing catalyst to be involved in curing of the above resin. The curing resin may be a catalyst that can control conditions such as the curing speed of the resin, the reactivity of the resin in curing, and the hardness of the cured resin.

The curing catalyst is preferably an organic compound (organic metal compound) including a metal component. The organic metal compound is not limited to a particular compound. An organic aluminum compound, an organic titanium compound, an organic zirconium compound, an organic zinc compound, an organic tin compound, or the like may be used as the organic metal compound.

The organic aluminum compound is, for example, but not limited to, an aluminum salt compound such as aluminum triacetate or hydroxyaluminium bis(2-ethylhexanoate), an aluminum alkoxide compound such as aluminum trimethoxide, aluminum triethoxide, aluminum dimethoxide, aluminum diethoxide, aluminum triallyl oxide, aluminum diallyl oxide, or aluminum isopropoxide, or an aluminum chelate compound such as aluminum methoxy bis(ethylacetoacetate), aluminum methoxy bis(acetylacetonate), aluminum ethoxy bis(ethylacetoacetate), aluminum ethoxy bis(acetylacetonate), aluminum isopropoxy bis(ethylacetoacetate), aluminum isopropoxy bis(methylacetoacetate), aluminum isopropoxy bis(t-butylacetoacetate), aluminum butoxy bis(ethylacetoacetate), aluminum dimethoxy (ethylacetoacetate), aluminum dimethoxy (acetylacetonate), aluminum diethoxy (ethylacetoacetate), aluminum diethoxy (acetylacetonate), aluminum diisopropoxy (ethylacetoacetate), aluminum diisopropoxy (methylacetoacetate), aluminum tris(ethylacetoacetate), or aluminum tris(acetylacetonate). One of these may be used alone, or two or more of these may be used in combination.

The organic titanium compound is, for example, but not limited to, a titanium chelate such as titanium tetraacetylacetonate, dibutyloxy titanium diacetylacetonate, titanium ethylacetoacetate, titanium octylene glycolate, or titanium lactate, or a titanium alkoxide such as tetraisopropyl titanate, tetrabutyl titanate, tetramethyl titanate, tetra(2-ethylhexyl titanate), titanium tetra-2-ethylhexoxide, titanium butoxy dimer, titanium tetra-normal-butoxide, titanium tetraisopropoxide, or titanium diisopropoxy bis(ethylacetoacetate). One of these may be used alone, or two or more of these may be used in combination.

The organic zirconium compound is, for example, but not limited to, a zirconium chelate such as zirconium tetraacetylacetonate, zirconium dibutoxy bis(ethylacetoacetate), zirconium monobutoxy acetylacetonate bis(ethylacetoacetate), zirconium tributoxy monoacetylacetonate, or zirconium tetraacetylacetonate, or a zirconium alkoxide such as zirconium tetra-normal-butoxide or zirconium tetra-normal-propoxide. One of these may be used alone, or two or more of these may be used in combination.

Examples of the organic zinc compound include zinc alkoxides such as dimethoxyzinc, diethoxyzinc, and ethylmethoxyzinc. One of these may be used alone, or two or more of these may be used in combination.

Examples of the organic tin compounds include tin alkoxides such as dimethyltin oxide, diethyltin oxide, dipropyltin oxide, dibutyltin oxide, dipentyltin oxide, dihexyltin oxide, diheptyltin oxide, and dioctyltin oxide. One of these may be used alone, or two or more of these may be used in combination.

The light absorber 10 or the light-absorbing composition being a precursor thereof may further include, as the curing catalyst, at least one selected from the group consisting of an alkoxide including a metal component and a hydrolysate of an alkoxide including a metal component, as described above. The alkoxide including the metal component and the hydrolysate of the alkoxide including the metal component are each referred to as “metal alkoxide compound”. The metal alkoxide compound is represented by a general formula M(OR)ₙ (where M is a metal element, and n is an integer of one or greater), and is a compound in which a hydrogen atom in a hydroxy group of an alcohol has been substituted with the metal element M. One molecule of the metal alkoxide compound forms M-OH by hydrolysis, and further forms an M-O-M bond by a reaction with another molecule of the metal alkoxide compound. For example, when the light-absorbing composition being fluid and including a compound such as the curable resin is cured into the light absorber 10, the metal alkoxide compound may be one that can function as a catalyst for promoting curing of the light-absorbing composition. In the case of curing the light-absorbing composition by a heating treatment, the higher the heat treatment temperature is, the more likely a tolerance to environmental conditions, such as thermal resistance is to be enhanced. However, a high heat treatment temperature may decrease properties of some types of light-absorbing compound or an ultraviolet absorbent described later. A decrease in properties of the ultraviolet absorbent may shift the wavelength of light the ultraviolet absorbent absorbs from an intended absorption wavelength. A decrease in properties of the ultraviolet absorbent may also decrease or eliminate the absorbing ability of the ultraviolet absorbent. However, in the case of the light absorber 10 including the metal alkoxide compound, it is possible to promote curing of the light-absorbing composition even at a low heating treatment temperature. As a result, the light absorber 10 is likely to have a high tolerance to environmental conditions.

The metal component included in the metal alkoxide compound is not limited to a particular component. Examples of the metal component include Al, Ti, Zr, Zn, Sn, and Fe. Examples of the metal alkoxide can include CAT-AC and DX-9740 each being an aluminum alkoxide manufactured by Shin-Etsu Chemical Co., Ltd., ORGATIX AL-3001 being an aluminum alkoxide manufactured by Matsumoto Fine Chemical Co., Ltd., aluminum isopropoxide being an aluminum alkoxide manufactured by Tokyo Chemical Industry Co., Ltd., D-20, D-25, and DX-175 each being a titanium alkoxide manufactured by Shin-Etsu Chemical Co., Ltd., ORGATIX TA-8, TA-21, TA-30, TA-80, and TA-90 each being a titanium alkoxide manufactured by Matsumoto Fine Chemical Co., Ltd., D-15 and D-31 each being a zirconium alkoxide manufactured by Shin-Etsu Chemical Co., Ltd., and ORGATIX ZA-45 and ZA-65 each being a zirconium alkoxide manufactured by Matsumoto Fine Chemical Co., Ltd.

A ratio of the amount of the copper component to the amount of the metal component included in the metal alkoxide compound in the light absorber 10 is not limited to a particular value. The ratio of the amount of the copper component to the amount of the metal component included in the metal alkoxide compound in the light absorber 10 may be, on a mass basis, 1×10² to 7×10², preferably 2×10² to 6×10², and even more preferably 3×10² to 5×10².

Furthermore, a ratio of the amount of the phosphorus component to the amount of the metal component included in the metal alkoxide compound in the light absorber 10 is not limited to a particular value. The ratio of the amount of the phosphorus component to the amount of the metal component included in the metal alkoxide compound in the light absorber 10 may be, on a mass basis, 0.5×10² to 5×10², preferably 1×10² to 4×10², and even more preferably 1.5×10² to 3×10².

### (Ultraviolet Absorbent)

The light absorber 10 or the light-absorbing composition being a precursor thereof may include an ultraviolet absorbent that absorbs a portion of light belonging to ultraviolet light. The ultraviolet absorbent is not limited to a particular compound as long as the transmission spectrum of the light absorber 10 at an incident angle of 0° satisfies the requirements (I) to (VI). The ultraviolet absorbent is, for example, a compound not having both a hydroxy group and a carbonyl group per molecule, the compound not having both a hydroxy group and a carbonyl group in one molecule when expressed in a structural formula. Curing of the light-absorbing composition can be promoted, for example, by coordination of a reaction product or a precursor to a particular position in a molecule such as the alkoxide including the metal component. For example, if there is a group that is more likely to coordinate to a substance other than a substance provided for a reaction for curing of the light-absorbing composition, the action of the catalyst may be reduced. In particular, if the ultraviolet absorbent had a hydroxy group and a carbonyl group, both of which have a high electron-donating ability, the alkoxide compound and the ultraviolet absorbent might partly form a complex through a reaction or coordination, changing inherent ultraviolet absorption properties of the ultraviolet absorbent. However, it is difficult for the alkoxide compound to form a complex with the ultraviolet absorbent being a compound not having both a hydroxy group and a carbonyl group per molecule, and thus the ultraviolet absorbent is likely to exhibit its inherent ultraviolet absorption properties. It should be noted that the ultraviolet absorbent may include either a hydroxy group or a carbonyl group per molecule.

The ultraviolet absorbent is selected desirably in view of absorbing light in a desired wavelength range, having compatibility with a particular solvent, dispersing well in the light-absorbing composition, particularly, for example, the curable resin, having an excellent tolerance to environmental conditions, and the like. Examples of the ultraviolet absorbent include a benzophenone-based compound, a benzotriazole-based compound, a salicylic-acid-based compound, and a triazine-based compound. For example, Tinuvin PS, Tinuvin 99-2, Tinuvin 234, Tinuvin 326, Tinuvin 329, Tinuvin 900, Tinuvin 928, Tinuvin 405, and Tinuvin 460 can be used as the ultraviolet absorbent. These are ultraviolet absorbents manufactured by BASF, and Tinuvin is a registered trademark.

The amount of the ultraviolet absorbent in the light absorber 10 is not limited to a particular value as long as the transmission spectrum of the light absorber 10 at an incident angle of 0° satisfies the requirements (I) to (VI). A high absorbing ability can be exhibited even with a small amount of the ultraviolet absorbent. A ratio of the amount of the ultraviolet absorbent to the amount of the copper component in the light absorber 10 is, for example, 0.01 to 1, desirably 0.02 to 0.5, and more desirably 0.07 to 0.14 on a mass basis. A ratio of the amount of the ultraviolet absorbent to the phosphorus component in the light absorber 10 is, for example, 0.02 to 2, desirably 0.04 to 1, more desirably 0.12 to 0.26 on a mass basis.

As shown in FIG. 1, the light absorber 10 is in the form of, for example, a film. The term “film” as used herein means a coating or a layer. The form of the light absorber 10 is not limited to a film form.

A thickness of the light absorber 10 is not limited to a particular value as long as the transmission spectrum of the light absorber 10 at an incident angle of 0° satisfies the requirements (I) to (VI). The thickness of the light absorber 10 is, for example, 120 μm or less, desirably 100 μm or less, and more desirably 80 μm or less. A small thickness of the light absorber 10 is advantageous in terms of lowering the profile of an imaging apparatus including the light absorber 10.

In view of imparting flexibility to the light absorber 10 in a film form and making it possible to include, as a light absorbent, the light-absorbing compound including the phosphonic acid and the copper component and having excellent light-absorbing properties, a silicone resin is preferably included as the curable resin. Additionally, the curing catalyst may be added to enhance the curability of the resin such as a silicone resin. A preferable curing catalyst for a silicone resin is a compound including a metal component, such as a chelate including a metal component or an alkoxide including a metal component. Conventionally, in the case where an ultraviolet absorbent is added to adjust the short wavelength side of a spectrum, an interaction between a metal component in, for example, a curing catalyst and the ultraviolet absorbent occurs. In some cases, the interaction changes inherent absorption properties of the ultraviolet absorbent; for example, a cut-off wavelength on the short wavelength side shows a great shift. Therefore, conventionally, a layer including an ultraviolet absorbent and a resin layer including a light absorbent including a phosphonic acid and copper need to be prepared as separate layers, and thus the resulting light absorber tends to be thick. In the present invention, a particular ultraviolet absorbent is used so that the ultraviolet absorbent can be included in a single layer or single-layer film including a curing catalyst for a resin, the curing catalyst being composed of a compound including a metal component. That makes it possible to let the ultraviolet absorbent exhibit its inherent ultraviolet absorption performance, to obtain the light absorber 10 having a smaller number of layers, i.e., to reduce the thickness of the light absorber 10.

The light absorber 10 can be produced, for example, by curing a given light-absorbing composition.

The light-absorbing composition is not limited to a particular composition as long as the transmission spectrum of the light absorber 10 at an incident angle of 0° satisfies the requirements (I) to (VI). The light-absorbing composition may include, for example, a light-absorbing compound including a phosphonic acid and a copper component and an ultraviolet absorbent that absorbs at least a portion of ultraviolet light. For the light-absorbing compound, the description of the light-absorbing compound for the light absorber 10 can be referred to.

The light-absorbing composition further includes, for example, at least one selected from the group consisting of an alkoxide including a metal component and a hydrolysate of an alkoxide including a metal component. For the alkoxide including the metal component and the hydrolysate of the alkoxide including the metal component, the description of the alkoxide compound of the light absorber 10 can be referred to.

The ultraviolet absorbent in the light-absorbing composition is not limited to a particular compound as long as the transmission spectrum of the light absorber 10 at an incident angle of 0° satisfies the requirements (I) to (VI). For an example of the ultraviolet absorbent, the description of the ultraviolet absorbent of the light absorber 10 can be referred to. The ultraviolet absorbent is a compound, for example, not having both a hydroxy group and a carbonyl group per molecule. That is, the ultraviolet absorbent may be a compound including either a hydroxy group or a carbonyl group.

The light-absorbing composition may further include, for example, a phosphoric acid ester. In this case, the light-absorbing compound is likely to be appropriately dispersed in the light-absorbing composition. For the phosphoric acid ester, the description of the phosphoric acid ester of the light absorber 10 can be referred to.

The light-absorbing composition further includes, for example, a curable resin. For the curable resin, the description of the resin of the light absorber 10 can be referred to.

In preparation of the light-absorbing composition, a source of the copper component in the light-absorbing compound is not limited to a particular substance. The source of the copper component is, for example, a copper salt. The copper salt may be an anhydride or a hydrate of copper chloride, copper formate, copper stearate, copper benzoate, copper pyrophosphate, copper naphthenate, or copper citrate. For example, copper acetate monohydrate is represented by Cu(CH₃COO)₂·H₂O, and 1 mol of copper acetate monohydrate provides 1 mol of copper ion.

For example, a member including an article and the light absorber 10 provided on a surface of the article can be used as an optical filter. The light absorber 10 as itself can also be used as an optical filter after peeled off from a surface of an article where the light absorber 10 was formed. The method for producing the light absorber 10 is not limited to a particular method. The light absorber 10 may be produced by a method such as casting, compression molding, vacuum molding, press molding, injection molding, blow molding, or extrusion molding.

As shown in FIG. 1A, the light absorber 10 may be used on its own. Meanwhile, as shown in FIG. 1B, an article 1a with a light absorber can be provided. The article 1a includes an article 20 and the light absorber 10. The light absorber 10 covers at least a portion of a surface of the article 20.

The shape of the article 20 of the article 1a is not limited to a particular shape. The article 20 may be a flat-plate-shaped member or a substrate. The article 20 is not limited to a particular article. The article 20 may be, for example, an optical element (including an acousto-optic device) such as a lens, a mirror, a prism, a diffuser, a planar microlens array, a polarizer, a diffraction grating, a hologram, an optical modulation device, an optical deflection device, or a filter. The article 20 may be a solid-state image sensing device, a light-transmitting shield such as a window of a building, an automotive window, a windshield, a helmet, or goggles, or a display apparatus such as a display or a screen. The article 1a may be a so-called optical filter. The surface of the article 20 covered by the light absorber 10 may be a plane surface, a curved surface, or a surface with asperities.

The light absorber 10 may be obtained by shaping the light-absorbing composition into an optical element such as a lens. In that case, the light absorber 10 may be used on its own.

### (Functional Film)

As shown in FIG. 1C and FIG. 1D, the article 1a or the light absorber 10 may include an additional functional film 30. The additional functional film is not limited to a particular film. The additional functional film may be a hard coating film (hart coat) for enhancement in scratch resistance, a reflection reduction film or an antireflection film (hereinafter each referred to as “antireflection film”) for, upon incidence of light on the article 1a or the light absorber 10, reducing light belonging to a particular wavelength range and reflected by a surface of the article 1a or the light absorber 10 or for preventing occurrence of such reflected light, a film (hereinafter referred to as “reflecting film”) for, upon incidence of light on the article 1a or the light absorber 10, reflecting a larger amount of light belonging to a particular wavelength range and reflected by a surface of the article 1a or the light absorber 10, a polarizing film for, upon incidence of light on the article 1a or the light absorber 10, lowering the transmittance of light having a polarization direction different from a particular direction, or a wavelength-selective light-absorbing film for absorbing light within a limited wavelength range, for example, by virtue of its configuration different from those mentioned above or by a given action. The functional film 30 may be composed of a single film being one of these functional films, or may be composed of two or more of these functional films.

When the article 1a or the light absorber 10 is provided with an antireflection film as the functional film 30, one or both of principal surfaces of the article 1a or the light absorber 10 may be provided with the antireflection film. Here, the term “principal surface” refers to a surface of the substrate such as the article 1a or the light absorber 10, the surface having the largest area.

The antireflection film includes, for example, one or more layers made of one or more materials. The material of the antireflection film is not limited to a particular material. The antireflection film may be, for example, a film formed by a sol-gel process or the like and including SiO₂ and SiO_{1.5} or TiO₂ and TiO_{1.5} as main components or may be a film including SiO₂ and SiO_{1.5} or TiO₂ and TiO_{1.5} as main components in which fine hollow particles or fine particles of a low refractive index material are dispersed. The antireflection film may be a film including TiO₂, Ta₂O₃, SiO₂, Nb₂O₅, ZnS, MgF, or a mixture thereof and formed by a method such as deposition, sputtering, or ion plating. The deposition may be ion-beam-assisted deposition. The antireflection film may be a single-layer film including any of the above materials or a multilayer film (dielectric multilayer film) in which films of different materials are alternately stacked. The antireflection film may be arranged in contact with the light absorber 10, or may be arranged in contact with another functional layer film arranged in contact with the light absorber 10.

Additionally, when the article 1a or the light absorber 10 includes a light-reflecting film as the functional film 30, a light blocking function may be exhibited by cooperation between the light absorber 10 and the light-reflecting film. Since transmission of light belonging to a particular wavelength range can be reduced or such light can be blocked by cooperation between the light absorber 10 and the light-reflecting film, light absorption properties required of the light absorber 10 can be reduced. Therefore, for example, the thickness of the light absorber 10 can be reduced. Furthermore, the amount of the light-absorbing compound such as the light absorbent or that of the ultraviolet absorbent in the light absorber 10 can be reduced.

The wavelength-selective light-absorbing film is not limited to a particular film, and may be a film made of a metal such as Ag (silver), Al (aluminum), Au (gold), or Pt (platinum) or may be a film including a compound including one or more of these metals or one or more of metals other than these metals. In particular, because having a wide reflection or absorption wavelength range and a simple structure, a metal film can be used as a readily available film capable of exhibiting a light reflection function or a light absorption function. Such a wavelength-selective light-absorbing film can be used as a neutral density (ND) filter or a one-way mirror.

In the case where an ultraviolet absorbent including both a hydroxy group and a carbonyl group is included in a light absorber, a reaction between the metal ion included in the functional film such as a reflecting film or an antireflection film and the ultraviolet absorbent can result in a structural change attributable to complex formation. The structural change causes a change, such as a shift of an absorption band to the long wavelength side, in ultraviolet absorbing ability, making it impossible to achieve necessary optical properties. The ultraviolet absorbent included in the light absorber 10 is composed of the compound not having both a hydroxy group and a carbonyl group per molecule, and thus has an advantage in that when a functional film including a metal component, such as Ti, Mg, or Ta, other than Si is provided, a change in optical properties due to a reaction between the metal component and the ultraviolet absorbent, particularly a transmittance decrease expected in the visible region, does not occur at an interface between the functional film and the light absorber. Another advantage is that defects such as delamination or wrinkling at the above interface due to a complex formation reaction can be reduced.

An apparatus including the light absorber 10 can be provided. Applications of the apparatus are not limited to particular applications. Examples of the apparatus include in-vehicle cameras and in-vehicle sensors. In these apparatuses, an image sensing device or a sensor device can be protected from ultraviolet light owing to the light absorber 10 having the given ultraviolet-absorbing properties. Since the light absorber 10 has a high transmittance at a wavelength around 700 nm, the light absorber 10 can be included in sensing systems, such as light detection and ranging (Lidar) systems, using an infrared or red laser. Since the light absorber 10 has a high transmittance, particularly, of red light, the apparatus including the light absorber 10 tends to have a high ability to recognize objects such as red traffic lights and road signs. Moreover, since the light absorber 10 can block light in a particular wavelength region by absorption, the apparatus including the light absorber 10 can reduce ghost and flare. Furthermore, Lidar systems can be installed not only in in-vehicle devices but in portable information terminals such as smartphones.

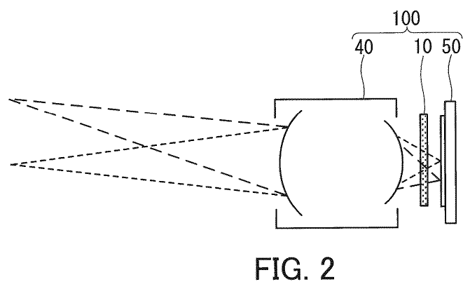

As shown in FIG. 2, for example, an imaging apparatus 100 including the light absorber 10 can be provided. The imaging apparatus 100 further includes, for example, a lens system 40 and an image sensing device 50. The light absorber 10 is disposed, for example, between the lens system 40 and the image sensing device 50. The imaging apparatus 100 is not limited to a particular product. The imaging apparatus 100 can be, for example, a camera module to be installed in portable information terminals such as smartphones, an apparatus to be mounted in in-vehicle sensing modules, or an apparatus to be mounted in sensing modules in unmanned aerial vehicles such as drones and unmanned surface vehicles (USVs). The light absorber 10 may be included in an ambient light sensor for detecting brightness of an environment, for example, around an apparatus in which the light absorber 10 is installed.

### EXAMPLES

The present invention will be described in more detail by examples. The present invention is not limited to the examples given below. First, methods for evaluating optical filters according to Examples and Comparative Examples will be described.

### (Measurement of Transmission Spectrum)

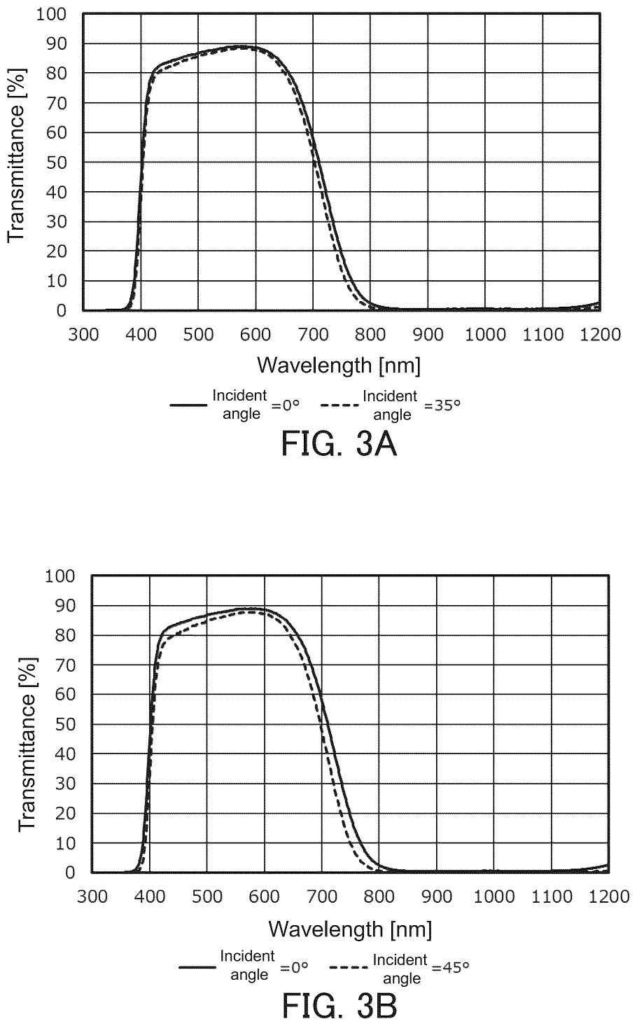

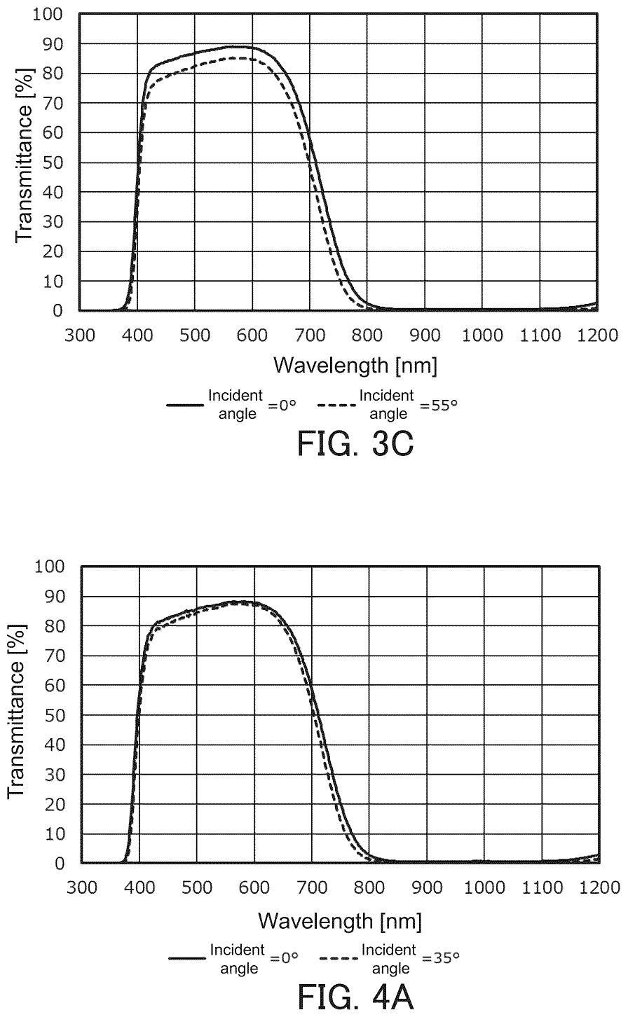

Transmission spectra were measured for each of the optical filters according to Examples at incident angles of 0°, 35°, 45°, and 55° using an ultraviolet-visible-near-infrared spectrophotometer V-670 manufactured by JASCO Corporation. FIG. 3A to FIG. 5C show transmission spectra of the optical filters according to Examples 1 to 3. In the same manner, transmission spectra were measured for each of the optical filters according to Comparative Examples at an incident angle of 0°. FIG. 6 to FIG. 9 show the results. Tables 7 to 9 show property values of each optical filter, the property values being obtained from these transmission spectra. The subscript “IA” shown in the items in Table 7 to 9 represents the incident angle [°].

### (Measurement of Thickness)

The thickness of each optical filter was measured using a laser displacement meter LK-H008 manufactured by Keyence Corporation. Table 3 shows the results.

### Example 1

An amount of 4.500 g of copper acetate monohydrate and 240 g of tetrahydrofuran (THF) were mixed and then stirred for three hours to obtain a copper acetate solution. To the copper acetate solution was added 2.572 g of a phosphoric acid ester compound PLYSURF A208N manufactured by DKS Co., Ltd., and the mixture was stirred for 30 minutes to obtain a solution A. Separately, 40 g of THF was added to 2.886 g of n-butylphosphonic acid, and the mixture was stirred for 30 minutes to obtain a solution B. The solution B was added to the solution A while the solution A was stirred, and the mixture was stirred at room temperature for 1 minute. To the resulting solution was then added 100 g of toluene, and the mixture was stirred at room temperature for 1 minute to obtain a solution C. This solution C was placed in a flask and subjected to solvent removal using a rotary evaporator (manufactured by Tokyo Rikakikai Co., Ltd.; product code: N-1110SF) under heating by means of an oil bath (manufactured by Tokyo Rikakikai Co., Ltd.; product code: OSB-2100). The temperature of the oil bath was controlled to 105° C. A solution D having been subjected to the solvent removal was then taken out of the flask. A composition α including a compound formed from a phosphonic acid and a copper component was obtained in this manner. It is inferred that fine particles of the compound formed from a phosphonic acid and a copper component were dispersed in the composition.

An amount of 5 g of a benzotriazole-based ultraviolet absorbent Tinuvin 326 manufactured by BASF was added to 95 g of toluene, and the mixture was stirred for 30 minutes to obtain a composition β-1 including an ultraviolet absorbent. It should be noted that Tinuvin 326 includes 2-[5-chloro-(2H)-benzotriazol-2-yl]-4-methyl-6-(tert-butyl) phenol represented by the following formula (b-1).

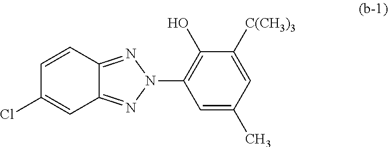 [SMILES: Cc1cc(-n2nc3ccc(Cl)cc3n2)c(O)c(C(C)(C)C)c1]

The composition α, 2.0 g of the composition β-1, 0.09 g of CAT-AC manufactured by Shin-Etsu Chemical Co., Ltd. and including an aluminum alkoxide compound were added to 8.80 g of a silicone resin KR-300 manufactured by Shin-Etsu Chemical Co., Ltd., and the mixture was stirred for 30 minutes to obtain a light-absorbing composition according to Example 1. Table 1 shows the amounts of the materials added for the preparation of the light-absorbing composition and the amounts of the given components in the light-absorbing composition. Table 4 shows the ratios of the amounts of the components. It should be noted that the average molecular weight of PLYSURF A208N used as a phosphoric acid ester was defined as 632 g/mol.

An amount of 0.1 g of an anti-smudge surface coating agent OPTOOL DSX (active ingredient concentration: 20 mass %) manufactured by DAIKIN INDUSTRIES, LTD. and 19.9 g of a hydrofluoroether-containing solution Novec 7100 manufactured by 3M Company were mixed and then stirred for 5 minutes to prepare a fluorine treatment agent (active ingredient concentration: 0.1 mass %). This fluorine treatment agent was applied by flow coating to a borosilicate glass (manufactured by SCHOTT AG; product name: D263 T eco) having dimensions of 130 mm×100 mm×0.70 mm. The glass substrate was left at room temperature for 24 hours to dry the coating film made of the fluorine treatment agent, and the glass surface was then wiped lightly with a dust-free cloth impregnated with Novec 7100 to remove an excess of the fluorine treatment agent. A fluorine-treated substrate was thus produced.

The light-absorbing composition according to Example 1 was applied with a dispenser to a 80 mm×80 mm region at a central portion of one principal surface of the fluorine-treated substrate to form a coating film. After sufficiently dried at room temperature, the fluorine-treated substrate and the coating film were put in an oven. The oven temperature was gradually increased from room temperature to 45° C. to evaporate the solvent for further drying, and a thermal treatment at 85° C. for 6 minutes was eventually performed to fully evaporate the solvent and cure the coating film. After that, the coating film was peeled off the fluorine-treated substrate to obtain an optical filter according to Example 1 consisting of a light absorber in a film form. FIG. 3A, FIG. 3B, and FIG. 3C show transmission spectra measured for the optical filter according to Example 1 at incident angles of 0° and 35°, incident angles of 0° and 45°, and incident angles of 0° and 55°, respectively. Table 7 shows parameters obtained from the transmission spectra.

### Example 2

An amount of 5.0 g of a benzotriazole-based ultraviolet absorbent Tinuvin 234 manufactured by BASF was added as an ultraviolet absorbent to 95.0 g of toluene, and the mixture was stirred for 30 minutes to prepare a composition β-2 including an ultraviolet absorbent. Tinuvin 234 includes 2-(2H-benzotriazol-2-yl)-4,6-bis(1-methyl-1-phenylethyl) phenol represented by the following formula (b-2). A light-absorbing composition according to Example 2 was prepared in the same manner as in Example 1, except that 3.6 g of the composition β-2 was added instead of 2.0 g of the composition β-1 in the preparation of the light-absorbing composition. Table 1 shows the amounts of the materials added for the preparation of the light-absorbing composition and the amounts of the given components in the light-absorbing composition. Table 4 shows the ratios of the amounts of the components.

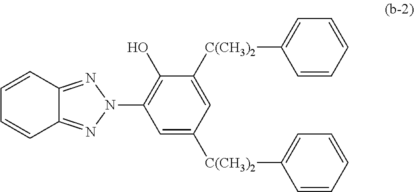

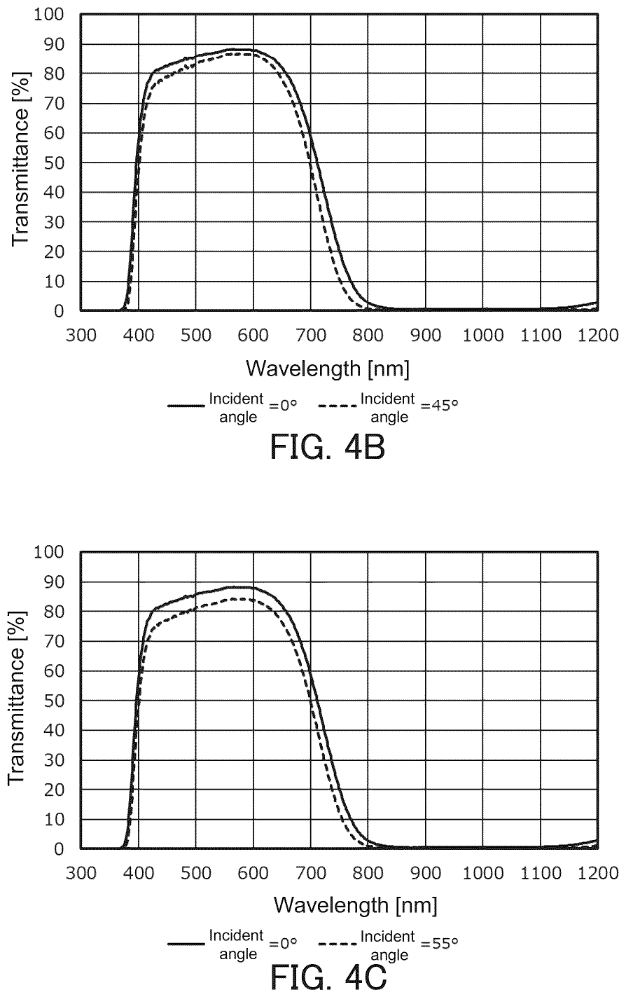

An optical filter according to Example 2 consisting of a light absorber in a film form was produced in the same manner as in Example 1, except that the light-absorbing composition according to Example 2 was used instead of the light-absorbing composition according to Example 1. FIG. 4A, FIG. 4B, and FIG. 4C show transmission spectra measured for the optical filter according to Example 1 at incident angles of 0° and 35°, incident angles of 0° and 45°, and incident angles of 0° and 55°, respectively. Table 7 shows parameters obtained from the transmission spectra.

### Example 3

An amount of 5.0 g of a benzotriazole-based ultraviolet absorbent Tinuvin 329 manufactured by BASF was added as an ultraviolet absorbent to 95.0 g of toluene, and the mixture was stirred for 30 minutes to prepare a composition β-3 including an ultraviolet absorbent. Tinuvin 329 includes 2,2-(2H-benzotriazol-2-yl)-4-(1,1,3,3-tetramethylbutyl) phenol represented by the following formula (b-3). A light-absorbing composition according to Example 3 was prepared in the same manner as in Example 1, except that 4.0 g of the composition β-3 was added instead of 2.0 g of the composition β-1 in the preparation of the light-absorbing composition. Table 1 shows the amounts of the materials added for the preparation of the light-absorbing composition and the amounts of the given components in the light-absorbing composition. Table 4 shows the ratios of the amounts of the components.

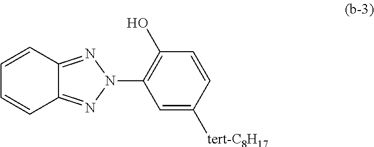

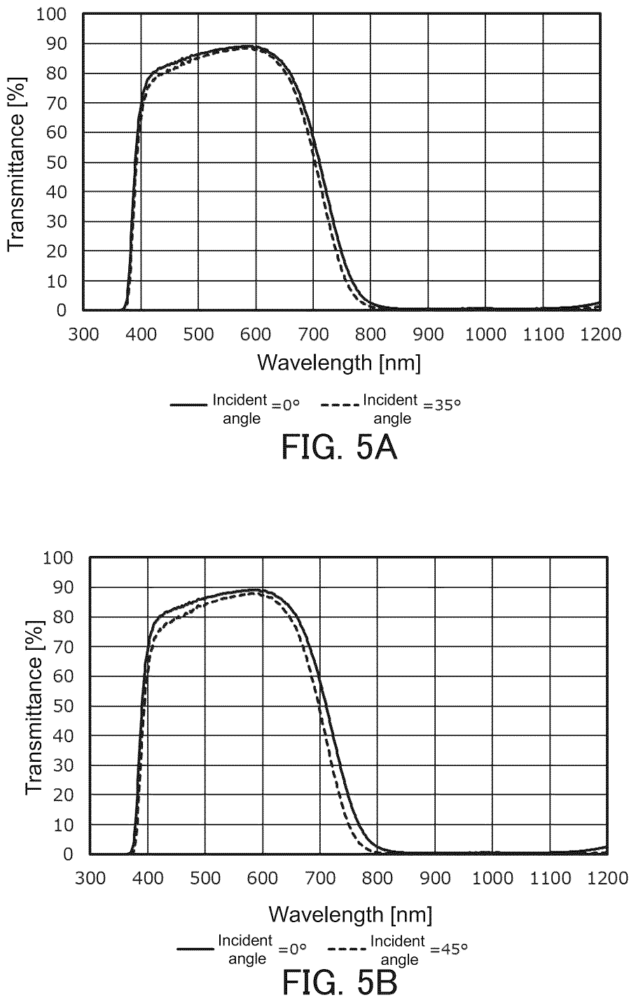

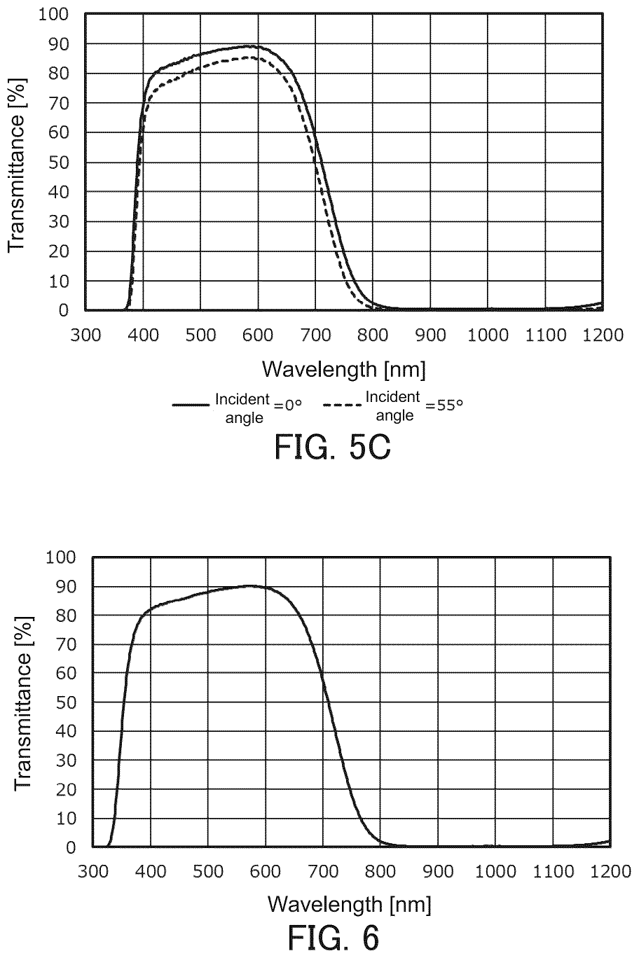

An optical filter according to Example 3 consisting of a light absorber in a film form was produced in the same manner as in Example 1, except that the light-absorbing composition according to Example 3 was used instead of the light-absorbing composition according to Example 1. FIG. 5A, FIG. 5B, and FIG. 5C show transmission spectra measured for the optical filter according to Example 3 at incident angles of 0° and 35°, incident angles of 0° and 45°, and incident angles of 0° and 55°, respectively. Table 7 shows parameters obtained from the transmission spectra.

### Example 4

A light-absorbing composition according to Example 4 was prepared in the same manner as in Example 1, except that 0.025 g of aluminum isopropoxide (amount of Al component: 13.21 mass %) manufactured by Tokyo Chemical Industry Co., Ltd. was added instead of CAT-AC including an aluminum alkoxide. Table 2 shows the amounts of the materials added for the preparation of the light-absorbing composition and the amounts of the given components in the light-absorbing composition. Table 5 shows the ratios of the amounts of the components.

An optical filter according to Example 4 consisting of a light absorber in a film form was produced in the same manner as in Example 1, except that the light-absorbing composition according to Example 4 was used instead of the light-absorbing composition according to Example 1. Transmission spectra were measured for the optical filter according to Example 4 at incident angles of 0°, 35°, 45°, and 55°. Table 8 shows parameters that can be obtained from the transmission spectra at incident angles of 0° and 55° and by comparison of the transmission spectra.

### Example 5

A light-absorbing composition according to Example 5 was prepared in the same manner as in Example 1, except that 0.038 g of ORGATIX AL-3001 (amount of Al component: 10.7 mass %) manufactured by Matsumoto Fine Chemical Co., Ltd. and including aluminum tri-sec-butoxide was added instead of CAT-AC including an aluminum alkoxide. Table 2 shows the amounts of the materials added for the preparation of the light-absorbing composition and the amounts of the given components in the light-absorbing composition. Table 5 shows the ratios of the amounts of the components.

An optical filter according to Example 5 consisting of a light absorber in a film form was produced in the same manner as in Example 1, except that the light-absorbing composition according to Example 5 was used instead of the light-absorbing composition according to Example 1. Transmission spectra were measured for the optical filter according to Example 5 at incident angles of 0°, 35°, 45°, and 55°. Table 8 shows parameters that can be obtained from the transmission spectra at incident angles of 0° and 55° and by comparison of the transmission spectra.

### Example 6

A light-absorbing composition according to Example 6 was prepared in the same manner as in Example 1, except that 0.05 g of ORGATIX TA-8 (amount of Ti component: 16.9 mass %) manufactured by Matsumoto Fine Chemical Co., Ltd. and including titanium tetraisopropoxide was added instead of CAT-AC including an aluminum alkoxide. Table 2 shows the amounts of the materials added for the preparation of the light-absorbing composition and the amounts of the given components in the light-absorbing composition. Table 5 shows the ratios of the amounts of the components.

An optical filter according to Example 6 consisting of a light absorber in a film form was produced in the same manner as in Example 1, except that the light-absorbing composition according to Example 6 was used instead of the light-absorbing composition according to Example 1. Transmission spectra were measured for the optical filter according to Example 6 at incident angles of 0°, 35°, 45°, and 55°. Table 8 shows parameters that can be obtained from the transmission spectra at incident angles of 0° and 55° and by comparison of the transmission spectra.

### Example 7

A light-absorbing composition according to Example 7 was prepared in the same manner as in Example 2, except that 0.07 g of ORGATIX TA-30 (amount of Ti component: 8.5 mass %) manufactured by Matsumoto Fine Chemical Co., Ltd. and including titanium tetra-2-ethylhexoxide was added instead of CAT-AC including an aluminum alkoxide. Table 2 shows the amounts of the materials added for the preparation of the light-absorbing composition and the amounts of the given components in the light-absorbing composition. Table 5 shows the ratios of the amounts of the components.

An optical filter according to Example 7 consisting of a light absorber in a film form was produced in the same manner as in Example 2, except that the light-absorbing composition according to Example 7 was used instead of the light-absorbing composition according to Example 2. Transmission spectra were measured for the optical filter according to Example 7 at incident angles of 0°, 35°, 45°, and 55°. Table 8 shows parameters that can be obtained from the transmission spectra at incident angles of 0° and 55° and by comparison of the transmission spectra.

### Example 8

A light-absorbing composition according to Example 8 was prepared in the same manner as in Example 1, except that 0.06 g of ORGATIX ZA-45 (amount of Zr component: 21.0 mass %) manufactured by Matsumoto Fine Chemical Co., Ltd. and including zirconium tetra-normal-propoxide was added instead of CAT-AC including an aluminum alkoxide. Table 2 shows the amounts of the materials added for the preparation of the light-absorbing composition and the amounts of the given components in the light-absorbing composition. Table 5 shows the ratios of the amounts of the components.

An optical filter according to Example 8 consisting of a light absorber in a film form was produced in the same manner as in Example 1, except that the light-absorbing composition according to Example 8 was used instead of the light-absorbing composition according to Example 1. Transmission spectra were measured for the optical filter according to Example 8 at incident angles of 0°, 35°, 45°, and 55°. Table 8 shows parameters that can be obtained from the transmission spectra at incident angles of 0° and 55° and by comparison of the transmission spectra.

### Comparative Example 1

A light-absorbing composition according to Comparative Example 1 was prepared in the same manner as in Example 1, except that the composition β-1 was not added. Table 3 shows the amounts of the materials added for the preparation of the light-absorbing composition and the amounts of the given components in the light-absorbing composition. Table 6 shows the ratios of the amounts of the components.

An optical filter according to Comparative Example 1 consisting of a light absorber in a film form was produced in the same manner as in Example 1, except that the light-absorbing composition according to Comparative Example 1 was used instead of the light-absorbing composition according to Example 1. FIG. 6 shows a transmission spectrum of the optical filter according to Comparative Example 1 at an incident angle of 0°. Table 9 shows parameters that can be obtained from the transmission spectrum.

### Comparative Example 2

An amount of 2.0 g of hydroxybenzophenone-based ultraviolet absorbent Uvinul 3049 manufactured by BASF was added as an ultraviolet absorbent to 98.0 g of toluene, and the mixture was stirred for 30 minutes to prepare a composition β-4 including an ultraviolet absorbent. Uvinul 3049 includes a compound represented by the following formula (b-4). A light-absorbing composition according to Comparative Example 2 was prepared in the same manner as in Example 1, except that 5.0 g of the composition β-4 was added instead of 2.0 g of the composition β-1 in the preparation of the light-absorbing composition. Table 3 shows the amounts of the materials added for the preparation of the light-absorbing composition and the amounts of the given components in the light-absorbing composition. Table 6 shows the ratios of the amounts of the components.

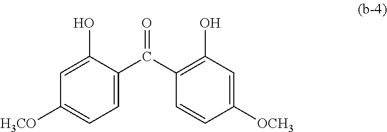 [SMILES: COc1ccc(C(=O)c2ccc(OC)cc2O)c(O)c1]

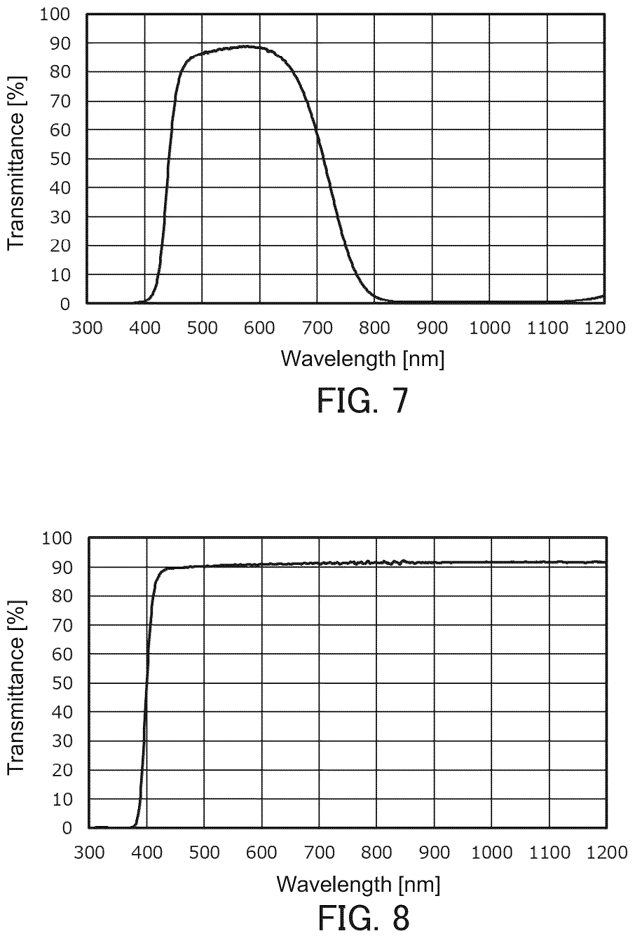

An optical filter according to Comparative Example 2 consisting of a light absorber in a film form was produced in the same manner as in Example 1, except that the light-absorbing composition according to Comparative Example 2 was used instead of the light-absorbing composition according to Example 1. FIG. 7 shows a transmission spectrum of the optical filter according to Comparative Example 2 at an incident angle of 0°. Table 9 shows parameters that can be obtained from the transmission spectrum.

### Comparative Example 3

An amount of 2.0 g of an ultraviolet absorbent Uvinul 3049 was added to 98.0 g of toluene, and the mixture was stirred for 30 minutes to produce a composition including an ultraviolet absorbent. An amount of 5.0 g of this composition was added to 10.0 g of a silicone resin KR-300 manufactured by Shin-Etsu Chemical Co., Ltd., and the mixture was stirred for 30 minutes to obtain a light-absorbing composition according to Comparative Example 3. Table 3 shows the amounts of the materials added for the preparation of the light-absorbing composition and the amounts of the given components in the light-absorbing composition. Table 6 shows the ratios of the amounts of the components.

An optical filter according to Comparative Example 3 consisting of a light absorber in a film form was produced in the same manner as in Example 1, except that the light-absorbing composition according to Comparative Example 3 was used instead of the light-absorbing composition according to Example 1. FIG. 8 shows a transmission spectrum of the optical filter according to Comparative Example 3 at an incident angle of 0°. Table 9 shows parameters that can be obtained from the transmission spectrum.

### Comparative Example 4

An amount of 2.0 g of an ultraviolet absorbent Uvinul 3049 was added to 98.0 g of toluene, and the mixture was stirred for 30 minutes to produce a composition including an ultraviolet absorbent. An amount of 5.0 g of this composition and 0.10 g of an aluminum alkoxide CAT-AC manufactured by Shin-Etsu Chemical Co., Ltd. were added to 10.0 g of a silicone resin KR-300 manufactured by Shin-Etsu Chemical Co., Ltd., and the mixture was stirred for 30 minutes to obtain a light-absorbing composition according to Comparative Example 4. Table 3 shows the amounts of the materials added for the preparation of the light-absorbing composition and the amounts of the given components in the light-absorbing composition. Table 6 shows the ratios of the amounts of the components.

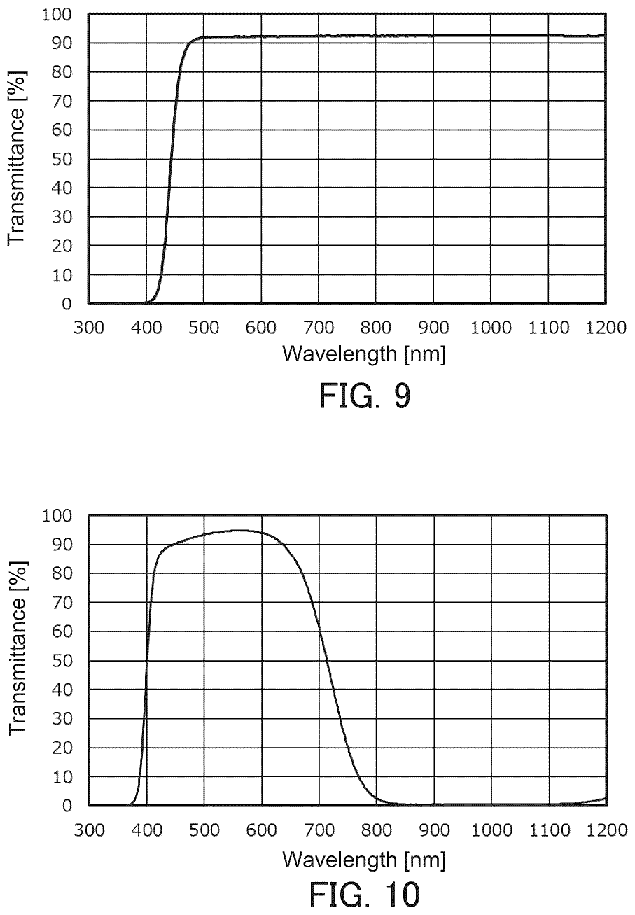

An optical filter according to Comparative Example 4 consisting of a light absorber in a film form was produced in the same manner as in Example 1, except that the light-absorbing composition according to Comparative Example 4 was used instead of the light-absorbing composition according to Example 1. FIG. 9 shows a transmission spectrum of the optical filter according to Comparative Example 4 at an incident angle of 0°. Table 9 shows parameters that can be obtained from the transmission spectrum.

As shown in Tables 7 and 8, according to the transmission spectra of the optical filters according to Examples, these optical filters have desired transmittance properties. On the other hand, according to the transmission spectrum of the optical filter according to Comparative Example 1 at an incident angle of 0°, the wavelength λ⁵⁰_{0(UV)} that lies in the wavelength range of 350 nm to 450 nm and at which the transmittance is 50% is 354 nm, and T^{M}₍₃₅₀₋₃₇₀₎ is more than 70%. Hence, it is difficult to say that the optical filter according to Comparative Example 1 has desired transmittance properties.

According to the transmission spectrum of the optical filter according to Comparative Example 2 at an incident angle of 0°, λ⁵⁰_{0(UV)} is 443 nm. Hence, it is difficult to say that the optical filter according to Comparative Example 2 has desired transmittance properties. From the fact that the ultraviolet absorbent Uvinul 3049 used to produce the optical filter according to Comparative Example 2 includes both a hydroxy group and a carbonyl group per molecule, it is inferred that the alkoxide compound including a metal component and serving as a catalyst and the ultraviolet absorbent partly reacted with each other to shift the inherent absorption wavelength of the ultraviolet absorbent to the long wavelength side.

Comparative Examples 3 and 4 are examples for discussing what difference will be made between transmission spectra of optical filters by the presence of an aluminum alkoxide in a light-absorbing composition. A difference between the light absorption properties of the optical filters according to Comparative Examples 3 and 4 appeared especially at the wavelength λ⁵⁰_{0(UV)} that lies in the wavelength range of 350 nm to 450 nm and at which the transmittance is 50%. For the optical filter according to Comparative Example 4 including both the ultraviolet absorbent and the aluminum alkoxide, the wavelength λ⁵⁰_{0(UV)} is 444 nm. On the other hand, for the optical filter according to Comparative Example 3 including no aluminum alkoxide, the wavelength λ⁵⁰_{0(UV)} is 400 nm. From these results, it is understood that when an ultraviolet absorbent including both a hydroxy group and a carbonyl group per a molecule is included along with an alkoxide compound, such as an aluminum alkoxide, including a metal component, inherent properties of the ultraviolet absorbent changes.

### Example 9

An antireflection film was formed on each of the two principal surfaces of the optical filter according to Example 1 by vacuum deposition to produce an optical filter according to Example 9. The antireflection film is a dielectric multilayer film in which SiO₂ layers and TiO₂ layers are stacked alternately. The number of layers in the antireflection film is nine, and the thickness of the antireflection film is approximately 0.4 μm. The optical filter according to Example 9 includes the light absorber according to Example 1 and the antireflection films formed on the two principal surfaces of the light absorber. FIG. 10 shows a transmission spectrum of the optical filter according to Example 9 at an incident angle of 0°. Table 8 shows parameters that can be obtained from the transmission spectrum.

TABLE 1

| | Materials used and amounts of materials added [g] | | | | | | | |
|---|---|---|---|---|---|---|---|---|
| | | Phosphoric | | | | | Curing catalyst | |
| | Phosphonic acid | acid ester | | Ultraviolet | | | (metal alkoxide) | |
| | n- | compound | | absorbent | | | | Amount of |
| | Butylphosphonic | PLYSURF | Copper acetate | | Amount | Resin | Amount | metal |
| | acid | A208N | monohydrate | Type | added | KR-300 | added | component |
| Ex. 1 | 2.886 | 2.572 | 4.500 | Tinuvin | 0.100 | 8.800 | 0.090 | 0.0036 |
| | | | | 326 | | | | |
| Ex. 2 | 2.886 | 2.572 | 4.500 | Tinuvin | 0.180 | 8.800 | 0.090 | 0.0036 |
| | | | | 234 | | | | |
| Ex. 3 | 2.886 | 2.572 | 4.500 | Tinuvin | 0.200 | 8.800 | 0.090 | 0.0036 |
| | | | | 329 | | | | |

TABLE 2

| | Materials used and amounts of materials added [g] | | | | | | | |
|---|---|---|---|---|---|---|---|---|
| | | Phosphoric | | | | | Curing catalyst | |
| | Phosphonic acid | acid ester | | | | | (metal alkoxide) | |
| | n- | compound | Copper | Ultraviolet absorbent | | | | Amount of |
| | Butylphosphonic | PLYSURF | acetate | | Amount | Resin | Amount | metal |
| | acid | A208N | monohydrate | Type | added | KR-300 | added | component |
| Ex. 4 | 2.886 | 2.572 | 4.500 | Tinuvin | 0.100 | 8.800 | 0.025 | 0.0033 |
| | | | | 326 | | | | |
| Ex. 5 | 2.886 | 2.572 | 4.500 | Tinuvin | 0.100 | 8.800 | 0.038 | 0.0041 |
| | | | | 326 | | | | |
| Ex. 6 | 2.886 | 2.572 | 4.500 | Tinuvin | 0.100 | 8.800 | 0.020 | 0.0034 |
| | | | | 326 | | | | |
| Ex. 7 | 2.886 | 2.572 | 4.500 | Tinuvin | 0.180 | 8.800 | 0.042 | 0.0036 |
| | | | | 234 | | | | |
| Ex. 8 | 2.886 | 2.572 | 4.500 | Tinuvin | 0.100 | 8.800 | 0.020 | 0.0042 |
| | | | | 326 | | | | |

TABLE 3

| | Materials used and amounts of materials added [g] | | | | | | | |
|---|---|---|---|---|---|---|---|---|
| | | Phosphoric | | | | | Curing catalyst | |
| | Phosphonic acid | acid ester | | | | | (metal alkoxide) | |
| | n- | compound | Copper | Ultraviolet absorbent | | | | Amount of |
| | Butylphosphonic | PLYSURF | acetate | | Amount | Resin | Amount | metal |
| | acid | A208N | monohydrate | Type | added | KR-300 | added | component |
| Comp. | 2.886 | 2.572 | 4.500 | — | 0.000 | 8.800 | 0.090 | 0.0036 |
| Ex. 1 | | | | | | | | |
| Comp. | 2.886 | 2.572 | 4.500 | Uvinul | 0.100 | 8.800 | 0.090 | 0.0036 |
| Ex. 2 | | | | 3049 | | | | |
| Comp. | — | — | — | Uvinul | 0.100 | 10.000 | — | — |
| Ex. 3 | | | | 3049 | | | | |
| Comp. | — | — | — | Uvinul | 0.100 | 10.000 | 0.100 | 0.0040 |
| Ex. 4 | | | | 3049 | | | | |

TABLE 4

| | | | | Mass ratio | Mass ratio of | | | |
|---|---|---|---|---|---|---|---|---|
| | | | | of copper | phosphorus | Mass ratio of | | Mass ratio of |
| | Mass ratio of | Mass ratio of | Mass ratio | component to | component to | phosphonic | Mass ratio of | phosphonic |
| | ultraviolet | ultraviolet | of copper | metal | metal | acid to | phosphonic | acid to |
| | absorbent to | absorbent to | component to | component in | component in | phosphoric | acid to | ultraviolet |
| | copper | phosphorus | phosphorus | metal alkoxide | metal alkoxide | acid ester | copper | absorbent |
| | component | component | component | (×10²) | (×10²) | compound | component | (×10¹) |
| Ex. 1 | 0.070 | 0.129 | 1.852 | 3.980 | 2.148 | 1.122 | 0.927 | 2.886 |
| Ex. 2 | 0.126 | 0.233 | 1.852 | 3.980 | 2.148 | 1.122 | 0.927 | 1.603 |
| Ex. 3 | 0.140 | 0.259 | 1.852 | 3.980 | 2.148 | 1.122 | 0.927 | 1.443 |

TABLE 5

| | | | | Mass ratio | Mass ratio of | | | |
|---|---|---|---|---|---|---|---|---|
| | | | | of copper | phosphorus | Mass ratio of | | Mass ratio of |
| | Mass ratio of | Mass ratio of | Mass ratio | component to | component to | phosphonic | Mass ratio of | phosphonic |
| | ultraviolet | ultraviolet | of copper | metal | metal | acid to | phosphonic | acid to |
| | absorbent to | absorbent to | component to | component in | component in | phosphoric | acid to | ultraviolet |
| | copper | phosphorus | phosphorus | metal alkoxide | metal alkoxide | acid ester | copper | absorbent |
| | component | component | component | (×10²) | (×10²) | compound | component | (×10¹) |
| Ex. 4 | 0.070 | 0.129 | 1.852 | 4.342 | 2.343 | 1.122 | 0.927 | 2.886 |
| Ex. 5 | 0.070 | 0.129 | 1.852 | 3.495 | 1.886 | 1.122 | 0.927 | 2.886 |
| Ex. 6 | 0.070 | 0.129 | 1.852 | 4.214 | 2.274 | 1.122 | 0.927 | 2.886 |
| Ex. 7 | 0.126 | 0.233 | 1.852 | 3.980 | 2.148 | 1.122 | 0.927 | 1.603 |
| Ex. 8 | 0.070 | 0.129 | 1.852 | 3.411 | 1.841 | 1.122 | 0.927 | 2.886 |

TABLE 6

| | | | | Mass ratio | Mass ratio of | | | |
|---|---|---|---|---|---|---|---|---|
| | | | | of copper | phosphorus | Mass ratio of | | Mass ratio of |
| | Mass ratio of | Mass ratio of | Mass ratio | component to | component to | phosphonic | Mass ratio of | phosphonic |
| | ultraviolet | ultraviolet | of copper | metal | metal | acid to | phosphonic | acid to |
| | absorbent to | absorbent to | component to | component in | component in | phosphoric | acid to | ultraviolet |
| | copper | phosphorus | phosphorus | metal alkoxide | metal alkoxide | acid ester | copper | absorbent |
| | component | component | component | (×10²) | (×10²) | compound | component | (×10¹) |
| Comp. | 0.000 | 0.000 | 1.852 | 3.980 | 2.148 | 1.122 | 0.927 | — |
| Ex. 1 | | | | | | | | |
| Comp. | 0.070 | 0.129 | 1.852 | 3.980 | 2.148 | 1.122 | 0.927 | 2.886 |
| Ex. 2 | | | | | | | | |
| Comp. | — | — | — | — | — | — | — | — |
| Ex. 3 | | | | | | | | |
| Comp. | — | — | — | — | — | — | — | — |
| Ex. 4 | | | | | | | | |

TABLE 7

| | Incident | | | | | | | | |
|---|---|---|---|---|---|---|---|---|---|
| | angle | T^{A}_{IA(450-600)} | λ⁵⁰_{IA(UV)} | λ⁵⁰_{IA(IR)} | T^{M}_{IA(350-370)} | T^{M}_{IA(800-900)} | T^{M}_{IA(1100-1200)} | T_{IA(750)} | T_{IA(760)} |
| | IA [°] | [%] | [nm] | [nm] | [%] | [%] | [%] | [%] | [%] |
| Ex. 1 | 0 | 87.33 | 402 | 710 | 0.37 | 2.41 | 2.64 | 19.01 | 13.28 |
| | 35 | 86.74 | 403 | 707 | 0.21 | 1.08 | 1.85 | 16.21 | 10.93 |
| | 45 | 86.09 | 404 | 703 | 0.12 | 0.53 | 1.25 | 13.60 | 8.82 |
| | 55 | 83.04 | 405 | 698 | 0.07 | 0.78 | 0.88 | 11.44 | 7.18 |
| Ex. 2 | 0 | 86.36 | 397 | 711 | 0.33 | 2.78 | 3.03 | 20.16 | 14.35 |
| | 35 | 85.68 | 398 | 708 | 0.19 | 1.96 | 2.15 | 17.29 | 11.90 |
| | 45 | 84.93 | 399 | 704 | 0.10 | 1.33 | 1.48 | 14.60 | 9.68 |
| | 55 | 81.84 | 401 | 699 | 0.06 | 0.94 | 1.05 | 12.34 | 7.94 |
| Ex. 3 | 0 | 87.01 | 390 | 711 | 0.44 | 2.43 | 2.62 | 19.13 | 13.45 |
| | 35 | 86.39 | 391 | 707 | 0.26 | 1.69 | 1.83 | 16.33 | 11.08 |
| | 45 | 85.71 | 392 | 703 | 0.14 | 1.13 | 1.23 | 13.71 | 8.95 |
| | 55 | 82.64 | 394 | 699 | 0.09 | 0.79 | 0.87 | 11.54 | 7.29 |

| | T_{IA(780)} | Δλ⁵⁰_{0/IA(UV)} | Δλ⁵⁰_{0/IA(IR)} | T^{A}_{IA(650-670)} | T^{A}_{IA(800-900)} | T^{A}_{IA(750-1100)} | T^{A}_{IA(750-1200)} | Thickness |
|---|---|---|---|---|---|---|---|---|
| | [%] | [nm] | [nm] | [%] | [%] | [%] | [%] | [μm] |
| Ex. 1 | 5.96 | — | — | 79.16 | 0.73 | 1.72 | 1.60 | 72 |
| | 4.52 | 1 | 3 | 77.85 | 0.46 | 1.28 | 1.17 | |
| | 3.34 | 2 | 7 | 76.44 | 0.28 | 0.95 | 0.85 | |
| | 2.53 | 3 | 12 | 73.08 | 0.18 | 0.73 | 0.64 | |
| Ex. 2 | 6.60 | — | — | 79.01 | 0.88 | 1.95 | 1.82 | 69 |
| | 5.06 | 1 | 3 | 77.69 | 0.56 | 1.46 | 1.34 | |
| | 3.78 | 2 | 7 | 76.27 | 0.35 | 1.08 | 0.97 | |
| | 2.89 | 4 | 12 | 72.90 | 0.23 | 0.83 | 0.74 | |
| Ex. 3 | 6.01 | — | — | 79.57 | 0.74 | 1.73 | 1.61 | 72 |
| | 4.57 | 1 | 4 | 78.30 | 0.46 | 1.29 | 1.18 | |
| | 3.38 | 2 | 8 | 76.92 | 0.28 | 0.96 | 0.85 | |
| | 2.56 | 4 | 12 | 73.58 | 0.18 | 0.74 | 0.64 | |

TABLE 8

| | Incident | | | | | | | | |
|---|---|---|---|---|---|---|---|---|---|
| | angle | T^{A}_{IA(450-600)} | λ⁵⁰_{IA(UV)} | λ⁵⁰_{IA(IR)} | T^{M}_{IA(350-370)} | T^{M}_{IA(800-900)} | T^{M}_{IA(1100-1200)} | T_{IA(750)} | T_{IA(760)} |
| | IA [°] | [%] | [nm] | [nm] | [%] | [%] | [%] | [%] | [%] |
| Ex. 4 | 0 | 87.44 | 402 | 711 | 0.24 | 2.52 | 2.75 | 19.12 | 13.37 |
| | 55 | 83.15 | 405 | 699 | 0.13 | 0.88 | 0.99 | 11.53 | 13.38 |
| Ex. 5 | 0 | 87.36 | 403 | 712 | 0.40 | 0.77 | 2.66 | 19.04 | 13.30 |
| | 55 | 83.07 | 406 | 699 | 0.10 | 0.81 | 0.91 | 11.46 | 7.23 |
| Ex. 6 | 0 | 87.32 | 402 | 711 | 0.28 | 2.62 | 2.85 | 19.22 | 13.49 |
| | 55 | 83.25 | 405 | 699 | 0.18 | 0.99 | 1.09 | 11.65 | 7.39 |
| Ex. 7 | 0 | 86.58 | 397 | 712 | 0.35 | 3.00 | 3.25 | 20.38 | 14.57 |
| | 55 | 82.06 | 401 | 700 | 0.28 | 1.16 | 1.27 | 12.56 | 8.16 |
| Ex. 8 | 0 | 87.62 | 402 | 711 | 0.45 | 2.70 | 2.93 | 19.30 | 12.57 |
| | 55 | 83.33 | 405 | 699 | 0.32 | 1.07 | 1.17 | 11.73 | 7.47 |
| Ex. 9 | 0 | 93.58 | 40 | 714 | 0.40 | 2.52 | 2.70 | 19.95 | 13.93 |

| | T_{IA(780)} | Δλ⁵⁰_{0/IA(UV)} | Δλ⁵⁰_{0/IA(IR)} | T^{A}_{IA(650-670)} | T^{A}_{IA(800-900)} | T^{A}_{IA(750-1100)} | T^{A}_{IA(750-1200)} | Thickness |
|---|---|---|---|---|---|---|---|---|
| | [%] | [nm] | [nm] | [%] | [%] | [%] | [%] | [μm] |
| Ex. 4 | 6.11 | — | — | 79.25 | 0.81 | 1.83 | 1.70 | 71 |
| | 6.09 | 3 | 12 | 73.17 | 0.27 | 0.83 | 0.77 | |
| Ex. 5 | 5.97 | — | — | 79.19 | 0.75 | 1.75 | 1.64 | 70 |
| | 2.57 | 3 | 13 | 73.10 | 0.20 | 0.77 | 0.67 | |
| Ex. 6 | 6.17 | — | — | 79.34 | 0.94 | 1.93 | 1.81 | 74 |
| | 2.74 | 3 | 12 | 73.29 | 0.38 | 0.94 | 0.86 | |
| Ex. 7 | 6.82 | — | — | 79.23 | 1.10 | 1.97 | 1.99 | 77 |
| | 3.11 | 4 | 12 | 73.12 | 0.45 | 1.05 | 0.96 | |
| Ex. 8 | 6.25 | — | — | 79.45 | 1.02 | 2.00 | 1.89 | 72 |
| | 2.82 | 3 | 12 | 73.37 | 0.47 | 1.02 | 0.93 | |
| Ex. 9 | 6.24 | — | — | 83.72 | 0.76 | 1.80 | 1.66 | 72 |

TABLE 9

| | Incident | | | | | | | | |
|---|---|---|---|---|---|---|---|---|---|
| | angle | T^{A}_{IA(450-600)} | λ⁵⁰_{IA(UV)} | λ⁵⁰_{IA(IR)} | T^{M}_{IA(350-370)} | T^{M}_{IA(800-900)} | T^{M}_{IA(1100-1200)} | T_{IA(750)} | T_{IA(760)} |
| | IA [°] | [%] | [nm] | [nm] | [%] | [%] | [%] | [%] | [%] |
| Comp. | 0 | 88.56 | 354 | 710 | 72.36 | 2.08 | 2.28 | 17.87 | 12.39 |
| Ex. 1 | | | | | | | | | |
| Comp. | 0 | 85.78 | 443 | 712 | 0.01 | 2.64 | 2.87 | 19.59 | 13.97 |
| Ex. 2 | | | | | | | | | |
| Comp. | 0 | 90.47 | 400 | | 0.04 | 92.26 | 91.87 | 91.31 | 91.81 |
| Ex. 3 | | | | | | | | | |
| Comp. | 0 | 90.19 | 444 | | 0.07 | 92.74 | 92.62 | 92.40 | 92.58 |
| Ex. 4 | | | | | | | | | |

| | T_{IA(780)} | Δλ⁵⁰_{0/IA(UV)} | Δλ⁵⁰_{0/IA(IR)} | T^{A}_{IA(650-670)} | T^{A}_{IA(800-900)} | T^{A}_{IA(750-1100)} | T^{A}_{IA(750-1200)} | Thickness |
|---|---|---|---|---|---|---|---|---|
| | [%] | [nm] | [nm] | [%] | [%] | [%] | [%] | [μm] |
| Comp. | 5.34 | | | 79.49 | 0.61 | 1.53 | 1.41 | 74 |
| Ex. 1 | | | | | | | | |
| Comp. | 6.35 | | | 79.16 | 0.82 | 1.85 | 1.73 | 70 |
| Ex. 2 | | | | | | | | |
| Comp. | 91.13 | | | 91.16 | 91.57 | 91.62 | 91.63 | 27 |
| Ex. 3 | | | | | | | | |
| Comp. | 92.51 | | | 92.36 | 92.50 | 92.53 | 92.51 | 29 |
| Ex. 4 | | | | | | | | |

1-18. (canceled)

19. A light-absorbing composition comprising:
a light-absorbing compound including a phosphonic acid; and
a copper component.

20. The light-absorbing composition according to claim 19, wherein
the light-absorbing composition is capable of being cured into a light absorber, a first transmitted light incident on the light absorber at an incident angle of 0° has a first transmission spectrum,
the first transmission spectrum has the following (i), (ii), (iii), (iv), (v) and (vi):
(i) an average transmittance of 75% or more in a wavelength range of 450 nm to 600 nm;
(ii) a first wavelength at which a transmittance is 50% in a wavelength range of 380 nm or more and 440 nm or less;
(iii) a second wavelength at which a transmittance is 50% in a wavelength range of 680 nm or more and 740 nm or less;
(iv) a maximum transmittance of 1% or less in a wavelength range of 350 nm to 370 nm;
(v) a maximum transmittance of 5% or less in a wavelength range of 800 nm to 900 nm;
(vi) a maximum transmittance of 5% or less in a wavelength range of 1100 nm to 1200 nm.

21. The light-absorbing composition according to claim 20, wherein the first transmission spectrum has the following (vii):
(vii) a transmittance of 7% or more at a wavelength of 750 nm.

22. The light-absorbing composition according to claim 21, wherein the first transmission spectrum has the following (viii):
(viii) a transmittance of 3% or more at a wavelength of 780 nm.

23. The light-absorbing composition according to claim 20,
wherein a second transmitted light incident on the light absorber at an incident angle of 55° has a second transmission spectrum, the second transmission spectrum has a third wavelength at which transmittance is 50% in a wavelength range of 350 nm to 450 nm, and
wherein an absolute value of difference between the first wavelength and the third wavelength is 12 nm or less.

24. The light-absorbing composition according to claim 23, wherein the second transmission spectrum has a fourth wavelength at which transmittance is 50% in a wavelength range of 650 nm to 750 nm, and
wherein an absolute value of difference between the second wavelength and the fourth wavelength is 24 nm or less.

25. The light-absorbing composition according to claim 19, further comprising an ultraviolet absorbent that absorbs at least a portion of ultraviolet light.

26. The light-absorbing composition according to claim 19, further comprising at least one selected from the group consisting of an alkoxide including a metal component and a hydrolysate of an alkoxide including a metal component.

27. The light-absorbing composition according to claim 25, the ultraviolet absorbent having either of a hydroxy group and a carbonyl group per molecule.

28. A light absorber made of a cured the light-absorbing composition according to claim 19.

29. The light absorber according to claim 28, wherein when a first transmitted light incident on the light absorber at an incident angle of 0° has a first transmission spectrum,
the first transmission spectrum has the following (I), (II), (III), (IV), (V) and (VI):
(I) an average transmittance of 75% or more in a wavelength range of 450 nm to 600 nm;
(II) a first wavelength at which a transmittance is 50% in a wavelength range of 380 nm or more and 440 nm or less;
(III) a second wavelength at which a transmittance is 50% in a wavelength range of 680 nm or more and 740 nm or less;
(IV) a maximum transmittance of 1% or less in a wavelength range of 350 nm to 370 nm;
(V) a maximum transmittance of 5% or less in a wavelength range of 800 nm to 900 nm;
(VI) a maximum transmittance of 5% or less in a wavelength range of 1100 nm to 1200 nm.

30. The light absorber according to claim 29, wherein the first transmission spectrum has the following (VII):
(VII) a transmittance of 7% or more at a wavelength of 750 nm.

31. The light absorber according to claim 30, wherein the first transmission spectrum has the following (VIII):
(VIII) a transmittance of 3% or more at a wavelength of 780 nm.

32. The light absorber according to claim 29,
wherein a second transmitted light incident on the light absorber at an incident angle of 55° has a second transmission spectrum, the second transmission spectrum has a third wavelength at which transmittance is 50% in a wavelength range of 350 nm to 450 nm, and
wherein an absolute value of difference between the first wavelength and the third wavelength is 12 nm or less.

33. The light absorber according to claim 32, wherein the second transmission spectrum has a fourth wavelength at which transmittance is 50% in a wavelength range of 650 nm to 750 nm, and
wherein an absolute value of difference between the second wavelength and the fourth wavelength is 24 nm or less.

34. The light absorber according to claim 28, further comprising at least one selected from the group consisting of an alkoxide including a metal component, a hydrolysate of an alkoxide including a metal component and a polymer of a hydrolysate of an alkoxide including a metal component.

35. The light absorber according to claim 28, the light-absorbing composition further including an ultraviolet absorbent that absorbs at least a portion of ultraviolet light, the ultraviolet absorbent having either of a hydroxy group and a carbonyl group per molecule.

36. A laminate comprising:
a dielectric multilayer film; and
the light absorber according to claim 28 provided on the dielectric multilayer film.

37. A camera module comprising, in sequence:
a plurality of lenses;
the light absorber according to claim 28; and
an image sensor.
